(19) United States
(12) Patent Application Publication
(10) Pub. No.: US 2009/0202748 A1
(43) Pub. Date: Aug. 13, 2009

(54) RESIN FILM, PRODUCTION METHOD THEREOF, POLARIZING PLATE AND LIQUID CRYSTAL DISPLAY DEVICE

(75) Inventors: Nobutaka Fukagawa, Minami-Ashigara-shi (JP); Masaki Noro, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/370,814

(22) Filed: Feb. 13, 2009

(30) Foreign Application Priority Data
Feb. 13, 2008 (JP) 2008-032289

(51) Int. Cl. C09K 19/02; B32B 9/04; C09K 19/34

(52) U.S. Cl. 428/1.1; 428/411.1; 252/299.61

(57) ABSTRACT

A resin film includes at least one liquid crystalline compound and a plasticizer having an octanol/water partition coefficient of from −2 to 4 and a molecular weight of from 200 to 1,400.

### CROSS-REFERENCE TO RELATED APPLICATIONS

This application claims the benefit of Japanese Patent Application JP 2008-032289, filed Feb. 13, 2008, the entire content of which is hereby incorporated by reference, the same as if set forth at length.

### FIELD OF THE INVENTION

The present invention relates to a resin film, a production method thereof, and a polarizing plate and a liquid crystal display device each using the resin film.

### BACKGROUND OF THE INVENTION

A liquid crystal display device is increasingly used year by year as a space-saving, less power-consuming image display device. It has been conventionally a great drawback of the liquid crystal display device that the viewing-angle dependency of the displayed image is large, but a wide viewing-angle liquid crystal mode such as VA mode is put into practical use and this allows rapid spreading of the demand for a liquid crystal display device also in the market where a high-quality image is required, such as television.

A VA-mode liquid crystal display device is advantageously assured of high contrast as compared with other liquid crystal display modes but has a problem that the contrast and color tint are greatly changed according to the viewing angle. In order to solve this problem, various optically compensatory methods have been heretofore proposed. For example, International Publication No. 03/032060 (corresponding to US2004/0239852A1) discloses a method of combining a retardation film where Re becomes smaller on the shorter wavelength side (hereinafter sometimes referred to as an “Re reverse-dispersion film”), with a retardation film where Rth becomes larger on the shorter wavelength side (hereinafter sometimes referred to as an “Rth forward dispersion film”).

The method of International Publication No. 03/032060 (corresponding to US2004/0239852A1) produces a large effect of improving the contrast change and color tint change but suffers from a problem that it is difficult to simultaneously satisfy other performances and the productivity. As for the Re reverse-dispersion film, a stretched film of modified polycarbonate (see, International Publication No. 03/032060 (corresponding to US2004/0239852A1)) and a stretched film of modified norbornene (see, JP-A-2003-292639 (the term “JP-A” as used herein means an “unexamined published Japanese patent application”)) have been heretofore disclosed, but there is a problem that the photoelastic coefficient is large in the former or adherence to polyvinyl alcohol used for the polarizer can be hardly ensured in the latter.

In this respect, the stretched cellulose acylate film disclosed in JP-A-2008-20896 is assured of a small photoelastic coefficient and excellent suitability for polarizing plate processing, but since a large amount of a retardation developer needs to be added, this film has a problem that a surface failure such as bleed-out readily occurs to reduce the productivity, and an improvement is demanded.

### SUMMARY OF THE INVENTION

An object of the present invention is to provide a resin film where Re has specific wavelength dispersion characteristics, the photoelastic coefficient is small, the adherence to a polarizer is excellent and the humidity dependency of retardation is small, and a low-cost production method thereof.

Another object of the present invention is to provide a polarizing plate and a liquid crystal display device, where by virtue of using the resin film, the contrast change and color tint change according to the viewing angle are small and even when used in a high-temperature high-humidity environment, display unevenness, light leakage and color tint change are difficult to occur.

The objects above are attained by the following means.
[1] A resin film containing at least one liquid crystalline compound and a plasticizer having an octanol/water partition coefficient (hereinafter, sometimes referred to as a “logP value”) of −2 to 4 and a molecular weight of 200 to 1,400.
[2] The resin film as described in [1], wherein the molar extinction coefficient of the plasticizer is 500 or less at all wavelengths of 200 to 700 nm.
[3] The resin film as described in [1] or [2], wherein the plasticizer is a carbohydrate derivative.
[4] The resin film as described in any one of [1] to [3], wherein a compound represented by the following formula (I) is contained as a liquid crystalline compound in an amount of 0.1 to 30 mass % based on the resin:

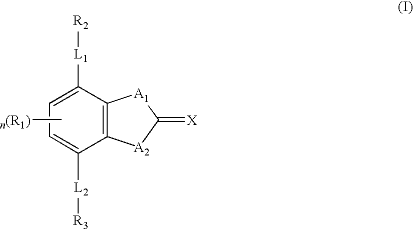

(wherein L₁ and L₂ each independently represents a single bond or a divalent linking group, A₁ and A₂ each independently represents a group selected from the group consisting of —O—, —NR— (R represents a hydrogen atom or a substituent), —S— and —CO—, R₁, R₂ and R₃ each independently represents a substituent, X represents an atom of Group 6, 5 or 4, and n represents an integer of 0 to 2).
[5] The resin film as described in any one of [1] to [4], wherein a compound represented by the following formula (1) is contained as a liquid crystalline compound in an amount of 0.1 to 30 mass % based on the resin:

Ar¹-L²-X-L³-Ar² Formula (1)

wherein Ar¹ and Ar² each independently represents an aromatic group, L² and L³ each independently represents a divalent linking group selected from a —O—CO— group and a —CO—O— group, and X represents a 1,4-cyclohexylene group, a vinylene group or an ethynylene group.

[6] The resin film as described in any one of [1] to [5], wherein Re satisfies the relations of the following formulae (1) to (4) and the photoelastic coefficient is from 0 to 30×10⁻⁸ cm²/N:

20 nm<Re(548)<300 nm (1)

0.5<Re(446)/Re(548)<1.0 (2)

1.0<Re(629)/Re(548)<2.0 (3)

0.1%≦[{(Re(548) at 25° C.—10% RH−Re(548) at 25° C.—80% RH)×100}/Re(548) at 25° C.—60% RH]≦20% (4)

(wherein Re(λ) indicates the in-plane retardation at a wavelength of λ).
[7] The resin film as described in any one of [1] to [6], wherein Re and the film thickness satisfy the relation of the following formula (5):

0.0005<Re(548)/film thickness<0.00700 (5)

(provided that in formula (5), Re(548) and the film thickness both are indicated in nm).
[8] The resin film as described in any one of [1] to [7], wherein a cellulose acylate is contained as a resin in an amount of 50 mass % or more.
[9] A polarizing plate having two protective films on both sides of a polarizer, wherein at least one of the protective films is the resin film described in any one of [1] to [8].
[10] A liquid crystal display device comprising a liquid crystal cell and two polarizing plates disposed on both sides of the liquid crystal cell, wherein at least one of the liquid crystal cell-side protective films of the polarizing plate is the resin film described in any one of [1] to [8].
[11] The liquid crystal display device as described in [10], wherein a liquid crystal cell-side protective film on the opposite side across the liquid crystal cell with respect to the liquid crystal cell-side protective film comprising the resin film described in any one of [1] to [8] satisfies the relations of the following formulae (8) to (12):

0 nm<Re(548)<20 nm (8)

100 nm<Rth(548)<300 nm (9)

10<Rth(548)/Re(548) (10)

1.0<Rth(446)/Rth(548)<2.0 (11)

0.5<Rth(629)/Rth(548)<1.0 (12)

(wherein Re(λ) and Rth(λ) indicate the in-plane retardation and the retardation in the thickness direction, respectively, at a wavelength of λ).
[12] The liquid crystal display device as described in [10] or [11], wherein the liquid crystal call is a VA-mode liquid crystal cell.

According to the present invention, a resin film having Re of reverse dispersion, small photoelastic coefficient, excellent adherence to a polarizer and small humidity dependency of retardation, and a low-cost production method thereof are provided.

Also, according to the present invention, a polarizing plate and a liquid crystal display device are provided, where by virtue of using the resin film, the contrast change and color tint change according to the viewing angle are small and even when used in a high-temperature high-humidity environment, display unevenness, light leakage and color tint change are difficult to occur.

### BRIEF DESCRIPTION OF THE DRAWINGS

FIG. 1 is a schematic view showing an example of the liquid crystal display device of the present invention.

### DESCRIPTION OF REFERENCE NUMERALS AND SIGNS

11 Upper polarizing plate
12 Direction of absorption axis of upper polarizing plate
13 Liquid crystal cell upper electrode substrate
14 Orientation control direction of upper substrate
15 Liquid crystal layer
16 Liquid crystal cell lower electrode substrate
17 Orientation control direction of lower substrate
10 Liquid crystal display device
18 Lower polarizing plate
19 Direction of absorption axis of lower polarizing plate

### DETAILED DESCRIPTION OF THE INVENTION

The resin film of the present invention contains at least one liquid crystalline compound and a plasticizer having an octanol/water partition coefficient (hereinafter, sometimes referred to as a “logP value”) of −2 to 4 and a molecular weight of 200 to 1,400.

At least one liquid crystalline compound and a plasticizer having a logP value of −2 to 4 and a molecular weight of 200 to 1,400 are present together and propagation of a shear force to a liquid crystalline compound from a matrix resin contained in the resin film is thereby facilitated at the film stretching, so that alignment of a liquid crystalline compound in the stretched film can be accelerated and development of retardation by a liquid crystalline compound can be increased.

The resin film of the present invention is described in detail below in order of a liquid crystalline compound, a plasticizer and a matrix resin.

### [Liquid Crystalline Compound]

The liquid crystalline compound preferably used in the present invention is described in detail.

The liquid crystalline compound for use in the present invention is aligned in a matrix resin in the resin film and thereby contributes to development of retardation of the resin film.

The liquid crystalline compound of the present invention needs to have a certain degree of compatibility with the matrix resin. That is, if the compatibility is too low, a failure such as bleed-out is readily caused, whereas if the compatibility is too high, the liquid crystalline compound is insufficiently aligned in the matrix resin and the retardation developability decreases.

The compatibility of the liquid crystalline compound for use in the present invention with the matrix resin can be related with the octanol/water partition coefficient (logP value).

In the case where a cellulose acylate with the acyl group having a carbon umber of 4 or less is used as the matrix resin, the logP value of the liquid crystalline compound for use in the present invention is preferably from 3 to 16, more preferably from 4 to 16, and most preferably from 5 to 15.

If the logP value is excessively high, compatibility with the matrix resin becomes insufficient and bleed-out is readily caused, whereas if it is too low, compatibility with the matrix resin is conversely too high and the liquid crystalline compound becomes difficult to align in the matrix resin.

The octanol/water partition coefficient (logP value) can be measured by a shake flask method described in JIS (Japanese Industrial Standards) Z7260-107 (2000). In place of the actual measurement, the octanol/water partition coefficient (logP value) can also be estimated by a chemically computational method or an empirical method. Preferred examples of the computational method include the Crippen's fragmentation method (see, J. Chem. Inf. Comput. Sci., 27, 21 (1987)), the Viswanadhan's fragmentation method (see, J. Chem. Inf. Comput. Sci., 29, 163 (1989)), and the Broto's fragmentation method (see, Eur. J. Med. Chem.-Chim. Theor., 19, 71 (1984)). Above all, the Crippen's fragmentation method (see, J. Chem. Inf. Comput. Sci., 27, 21 (1987)) is more preferred.

In the case where the logP value of a certain compound varies depending on the measuring method or computational method, as for whether the compound is within the range of the present invention or not, the value measured by the Crippen's fragmentation method is taken as the logP value in the present invention.

In the resin film of the present invention, the liquid crystalline compound is preferably a compound having both a positive intrinsic birefringent component and a negative intrinsic birefringent component (hereinafter sometimes referred to as a “reverse-dispersion liquid crystalline compound”).

The reverse-dispersion liquid crystalline compound for use in the resin film of the present invention includes a compound represented by the following formula (I).

The compound represented by the following formula (I) is preferably contained as a liquid crystalline compound in an amount of 0.1 to 30 mass % (weight %) based on the resin. By virtue of the liquid crystalline compound being the compound represented by the following formula (I), the retardation developability can be enhanced.

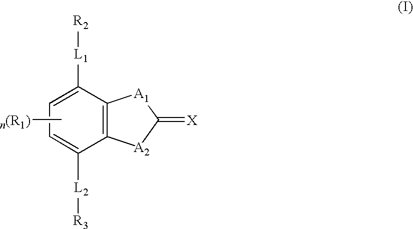

(wherein L₁ and L₂ each independently represents a single bond or a divalent linking group, A₁ and A₂ each independently represents a group selected from the group consisting of —O—, —NR— (R represents a hydrogen atom or a substituent), —S— and —CO—, R₁, R₂ and R₃ each independently represents a substituent, X represents an atom of Group 6, 5 or 4, and n represents an integer of 0 to 2).

The compound represented by formula (I) is more preferably a compound represented by the following formula (II):

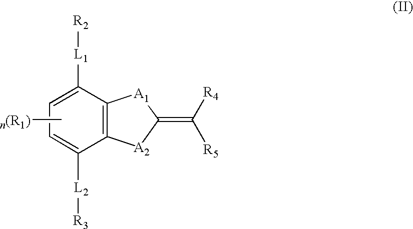

(wherein L₁ and L₂ each independently represents a single bond or a divalent linking group, A₁ and A₂ each independently represents a group selected from the group consisting of —O—, —NR— (R represents a hydrogen atom or a substituent), —S— and —CO—, R₁, R₂, R₃, R₄ and R₅ each independently represents a substituent, and n represents an integer of 0 to 2).

In formula (I) or (II), preferred examples of the divalent linking group represented by L₁ and L₂ include the followings.

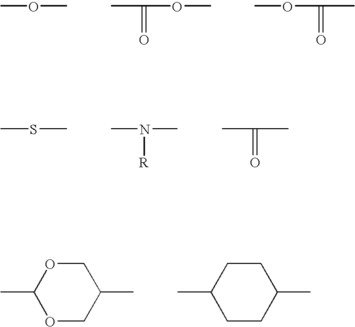

Among these, more preferred are —O—, —COO— and —OCO—.

In formulae (I) and (II), R₁ is a substituent and when a plurality of the substituents are present, these may be the same or different or may form a ring. Examples of the substituent include the followings:

a halogen atom (e.g., fluorine, chlorine, bromine, iodine), an alkyl group (preferably an alkyl group having a carbon number of 1 to 30, e.g., methyl, ethyl, n-propyl, isopropyl, tert-butyl, n-octyl, 2-ethylhexyl), a cycloalkyl group (preferably a substituted or unsubstituted cycloalkyl group having a carbon number of 3 to 30, e.g., cyclohexyl, cyclopentyl, 4-n-dodecylcyclohexyl), a bicycloalkyl group (preferably a substituted or unsubstituted bicycloalkyl group having a carbon number of 5 to 30, namely, a monovalent group obtained by removing one hydrogen atom from a bicycloalkane having a carbon number of 5 to 30, e.g., bicyclo[1,2,2]heptan-2-yl, bicyclo[2,2,2]octan-3-yl), an alkenyl group (preferably a substituted or unsubstituted alkenyl group having a carbon number of 2 to 30, e.g., vinyl, allyl), a cycloalkenyl group (preferably a substituted or unsubstituted cycloalkenyl group having a carbon number of 3 to 30, namely, a monovalent group obtained by removing one hydrogen atom form a cycloalkane having a carbon number of 3 to 30, e.g., 2-cyclopenten-1-yl, 2-cyclohexen-1-yl), a bicycloalkenyl group (a substituted or unsubstituted bicycloalkenyl group, preferably a substituted or unsubstituted bicycloalkenyl group having a carbon number of 5 to 30, namely, a monovalent group obtained by removing one hydrogen atom from a bicycloalkane having one double bond, e.g., bicyclo[2,2,1]hept-2-en-1-yl, bicyclo[2,2,2]oct-2-en-4-yl), an alkynyl group (preferably a substituted or unsubstituted alkynyl group having a carbon number of 2 to 30, e.g., ethynyl, propargyl), an aryl group (preferably a substituted or unsubstituted aryl group having a carbon number of 6 to 30, e.g., phenyl, p-tolyl, naphthyl), a heterocyclic group (preferably a monovalent group obtained by removing one hydrogen atom from a 5- or 6-membered substituted or unsubstituted, aromatic or non-aromatic heterocyclic compound, more preferably a 5- or 6-membered aromatic heterocyclic group having a carbon number of 3 to 30, e.g., 2-furyl, 2-thienyl, 2-pyrimidinyl, 2-benzothiazolyl), a cyano group, a hydroxyl group, a nitro group, a carboxyl group, an alkoxy group (preferably a substituted or unsubstituted alkoxy group having a carbon number of 1 to 30, e.g., methoxy, ethoxy, isopropoxy, tert-butoxy, n-octyloxy, 2-methoxyethoxy), an aryloxy group (preferably a substituted or unsubstituted aryloxy group having a carbon number of 6 to 30, e.g., phenoxy, 2-methylphenoxy, 4-tert-butylphenoxy, 3-nitrophenoxy, 2-tetradecanoylaminophenoxy), a silyloxy group (preferably a silyloxy group having a carbon number of 3 to 20, e.g., trimethylsilyloxy, tert-butyldimethylsilyloxy), a heterocyclic oxy group (preferably a substituted or unsubstituted heterocyclic oxy group having a carbon number of 2 to 30, e.g., 1-phenyltetrazol-5-oxy, 2-tetrahydropyranyloxy), an acyloxy group (preferably a formyloxy group, a substituted or unsubstituted alkylcarbonyloxy group having a carbon number of 2 to 30, and a substituted or unsubstituted arylcarbonyloxy group having a carbon number of 6 to 30, e.g., formyloxy, acetyloxy, pivaloyloxy, stearoyloxy, benzoyloxy, p-methoxyphenylcarbonyloxy), a carbamoyloxy group (preferably a substituted or unsubstituted carbamoyloxy group having a carbon number of 1 to 30, e.g., N,N-dimethylcarbamoyloxy, N,N-diethylcarbamoyloxy, morpholinocarbonyloxy, N,N-di-n-octylaminocarbonyloxy, N-n-octylcarbamoyloxy), an alkoxycarbonyloxy group (preferably a substituted or unsubstituted alkoxycarbonyloxy group having a carbon number of 2 to 30, e.g., methoxycarbonyloxy, ethoxycarbonyloxy, tert-butoxycarbonyloxy, n-octyl-carbonyloxy), an aryloxycarbonyloxy group (preferably a substituted or unsubstituted aryloxycarbonyloxy group having a carbon number of 7 to 30, e.g., phenoxycarbonyloxy, p-methoxyphenoxycarbonyloxy, p-n-hexadecyloxyphenoxy-carbonyloxy),

an amino group (preferably an amino group, a substituted or unsubstituted alkylamino group having a carbon number of 1 to 30, and a substituted or unsubstituted anilino group having a carbon number of 6 to 30, e.g., amino, methylamino, dimethylamino, anilino, N-methyl-anilino, diphenylamino), an acylamino group (preferably a formylamino group, a substituted or unsubstituted alkylcarbonylamino group having a carbon number of 1 to 30, and a substituted or unsubstituted arylcarbonylamino group having a carbon number of 6 to 30, e.g., formylamino, acetylamino, pivaloylamino, lauroylamino, benzoylamino), an aminocarbonylamino group (preferably a substituted or unsubstituted aminocarbonylamino group having a carbon number of 1 to 30, e.g., carbamoylamino, N,N-dimethylaminocarbonylamino, N,N-diethylaminocarbonylamino, morpholinocarbonylamino), an alkoxycarbonylamino group (preferably a substituted or unsubstituted alkoxycarbonyl-amino group having a carbon number of 2 to 30, e.g., methoxycarbonylamino, ethoxycarbonylamino, tert-butoxycarbonylamino, n-octadecyloxycarbonylamino, N-methyl-methoxycarbonylamino), an aryloxycarbonylamino group (preferably a substituted or unsubstituted aryloxycarbonyl-amino group having a carbon number of 7 to 30, e.g., phenoxycarbonylamino, p-chlorophenoxycarbonylamino, m-n-octyloxyphenoxycarbonylamino),
a sulfamoylamino group (preferably a substituted or unsubstituted sulfamoylamino group having a carbon number of 0 to 30, e.g., sulfamoylamino, N,N-dimethylamino-sulfonylamino, N-n-octylaminosulfonylamino), an alkyl- or arylsulfonylamino group (preferably a substituted or unsubstituted alkylsulfonylamino group having a carbon number of 1 to 30, and a substituted or unsubstituted arylsulfonylamino group having a carbon number of 6 to 30, e.g., methylsulfonylamino, butylsulfonylamino, phenyl-sulfonylamino, 2,3,5-trichlorophenylsulfonylamino, p-methylphenylsulfonylamino), a mercapto group, an alkylthio group (preferably a substituted or unsubstituted alkylthio group having a carbon number of 1 to 30, e.g., methylthio, ethylthio, n-hexadecylthio), an arylthio group (preferably a substituted or unsubstituted arylthio group having a carbon number of 6 to 30, e.g., phenylthio, p-chlorophenylthio, m-methoxyphenylthio), a heterocyclic thio group (preferably a substituted or unsubstituted heterocyclic thio group having a carbon number of 2 to 30, e.g., 2-benzothiazolylthio, 1-phenyltetrazol-5-ylthio), a sulfamoyl group (preferably a substituted or unsubstituted sulfamoyl group having a carbon number of 0 to 30, e.g., N-ethylsulfamoyl, N-(3-dodecyloxypropyl)-sulfamoyl, N,N-dimethylsulfamoyl, N-acetylsulfamoyl, N-benzoylsulfamoyl, N-(N′-phenylcarbamoyl)sulfamoyl), a sulfo group, an alkyl- or aryl-sulfinyl group (preferably a substituted or unsubstituted alkylsulfinyl group having a carbon number of 1 to 30, and a substituted or unsubstituted arylsulfinyl group having a carbon number of 6 to 30, e.g., methylsulfinyl, ethylsulfinyl, phenyl-sulfinyl, p-methylphenylsulfinyl), an alkyl- or aryl-sulfonyl group (preferably a substituted or unsubstituted alkylsulfonyl group having a carbon number of 1 to 30, and a substituted or unsubstituted arylsulfonyl group having a carbon number of 6 to 30, e.g., methylsulfonyl, ethylsulfonyl, phenylsulfonyl, p-methylphenylsulfonyl), an acyl group (preferably a formyl group, a substituted or unsubstituted alkylcarbonyl group having a carbon number of 2 to 30, and a substituted or unsubstituted arylcarbonyl group having a carbon number of 7 to 30, e.g., acetyl, pivaloylbenzoyl), an aryloxycarbonyl group (preferably a substituted or unsubstituted aryloxycarbonyl group having a carbon number of 7 to 30, e.g., phenoxycarbonyl, o-chlorophenoxycarbonyl, m-nitrophenoxycarbonyl, p-tert-butylphenoxycarbonyl), an alkoxycarbonyl group (preferably a substituted or unsubstituted alkoxycarbonyl group having a carbon number of 2 to 30, e.g., methoxycarbonyl, ethoxycarbonyl, tert-butoxycarbonyl, n-octadecyloxy-carbonyl), a carbamoyl group (preferably a substituted or unsubstituted carbamoyl group having a carbon number of 1 to 30, e.g., carbamoyl, N-methylcarbamoyl, N,N-dimethyl-carbamoyl, N,N-di-n-octylcarbamoyl, N-(methylsulfonyl)-carbamoyl),
an aryl- or heterocyclic-azo group (preferably a substituted or unsubstituted arylazo group having a carbon number of 6 to 30, and a substituted or unsubstituted heterocyclic azo group having a carbon number of 3 to 30, e.g., phenylazo, p-chlorophenylazo, 5-ethylthio-1,3,4-thiadiazol-2-ylazo), an imido group (preferably an N-succinimido group and an N-phthalimido group), a phosphino group (preferably a substituted or unsubstituted phosphino group having a carbon number of 2 to 30, e.g., dimethylphosphino, diphenylphosphino, methylphenoxy-phosphino), a phosphinyl group (preferably a substituted or unsubstituted phosphinyl group having a carbon number of 2 to 30, e.g., phosphinyl, dioctyloxyphosphinyl, diethoxyphosphinyl), a phosphinyloxy group (preferably a substituted or unsubstituted phosphinyloxy group having a carbon number of 2 to 30, e.g., diphenoxyphosphinyloxy, dioctyloxyphosphinyloxy), a phosphinylamino group (preferably a substituted or unsubstituted phosphinylamino group having a carbon number of 2 to 30, e.g., dimethoxyphosphinylamino, dimethylaminophosphinylamino), and a silyl group (preferably a substituted or unsubstituted silyl group having a carbon number of 3 to 30, e.g., trimethylsilyl, tert-butyldimethylsilyl, phenyl-dimethylsilyl).

Out of the above-described substituents, those having a hydrogen atom may be deprived of the hydrogen atom and be further substituted by a group above. Examples of such a functional group include an alkylcarbonylaminosulfonyl group, an arylcarbonylaminosulfonyl group, an alkyl-sulfonylaminocarbonyl group and an arylsulfonylamino-carbonyl group. Examples thereof include a methylsulfonyl-aminocarbonyl group, a p-methylphenylsulfonylaminocarbonyl group, an acetylaminosulfonyl group and a benzoyl-aminosulfonyl group.

R₁ is preferably a halogen atom, an alkyl group, an alkenyl group, an aryl group, a heterocyclic group, a hydroxyl group, a carboxyl group, an alkoxy group, an aryloxy group, an acyloxy group, a cyano group, an amino group or a hydrogen atom, more preferably a halogen atom, an alkyl group, a cyano group, an alkoxy group or a hydrogen atom.

R₂ and R₃ each independently represents a substituent. Examples thereof include those of R₁ described above. The substituent is preferably a substituted or unsubstituted benzene ring or a substituted or unsubstituted cyclohexane ring, more preferably a benzene ring having a substituent or a cyclohexane ring having a substituent, still more preferably a benzene ring having a substituent at the 4-position or a cyclohexane ring having a substituent at the 4-position.

R₄ and R₅ each independently represents a substituent. Examples thereof include those of R₁ described above. The substituent is preferably an electron-withdrawing substituent having a Hammett's substituent constant σₚ value of more than zero, more preferably an electron-withdrawing substituent having a σₚ value of 0 to 1.5. Examples of such a substituent include a trifluoromethyl group, a cyano group, a carbonyl group and a nitro group. R₄ and R₅ may combine together to form a ring.

Here, the Hammett's substituent constants σₚ and σₘ are described in detail, for example, in Naoki Inamoto, Hammett Soku-Kozo to Hannousei—(Hammett's Rule—Structure and Reactivity-), Maruzen; Shin-Jikken Kagaku Koza 14, Yuki Kagobutsu no Gosei to Hanno V (New Experimental Chemistry Course 14, Synthesis and Reaction V of Organic Compound), page 2605, edited by The Chemical Society of Japan, Maruzen; Tadao Nakaya, Riron Yuki Kagaku Kaisetsu (Theoretical Organic Chemistry Handbook), page 217, Tokyo Kagaku Dojin; and Chemical Review, Vol. 91, pp. 165-195 (1991).

A₁ and A₂ each is independently a group selected from the group consisting of —O—, —NR— (wherein R is a hydrogen atom or a substituent), —S— and —CO—, preferably —O—, —NR— (wherein R is a substituent) or —S—. Examples of the substituent R include those described above as examples of R₁.

Specific examples of the compound represented by formula (I) or (II) are set forth below, but the present invention is not limited to the following specific examples. Unless otherwise indicated, the compounds below are indicated as Compound (X) by using the number in the parenthesis.

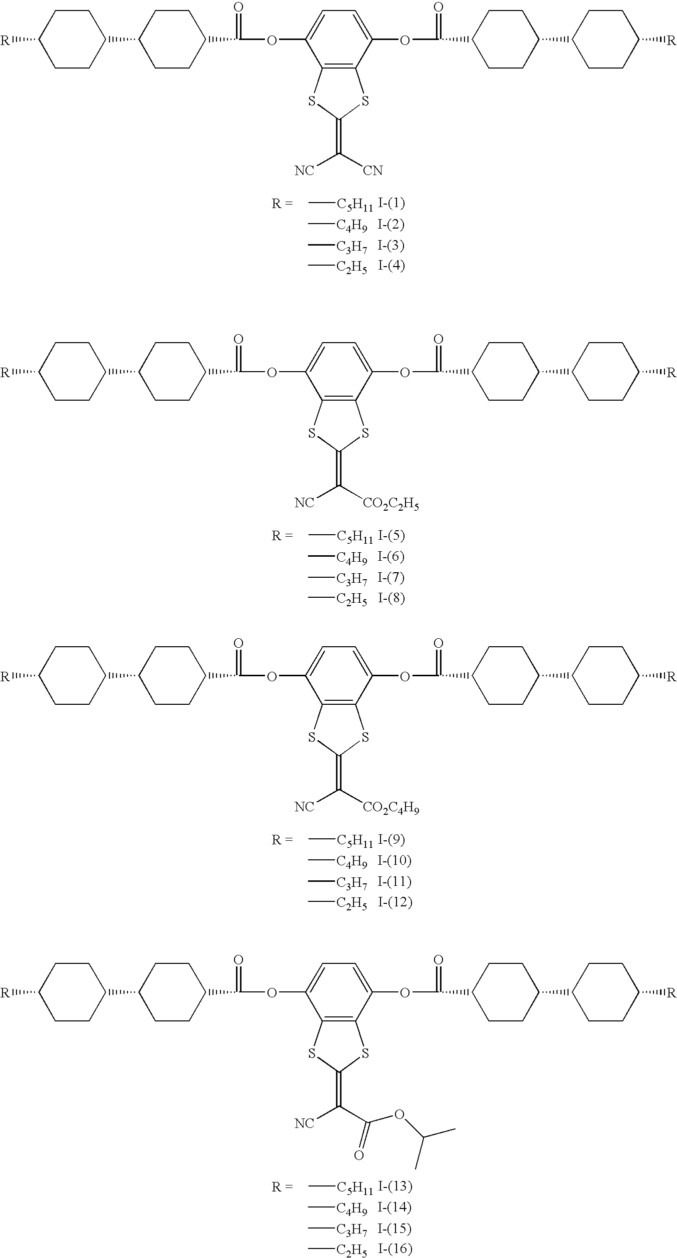

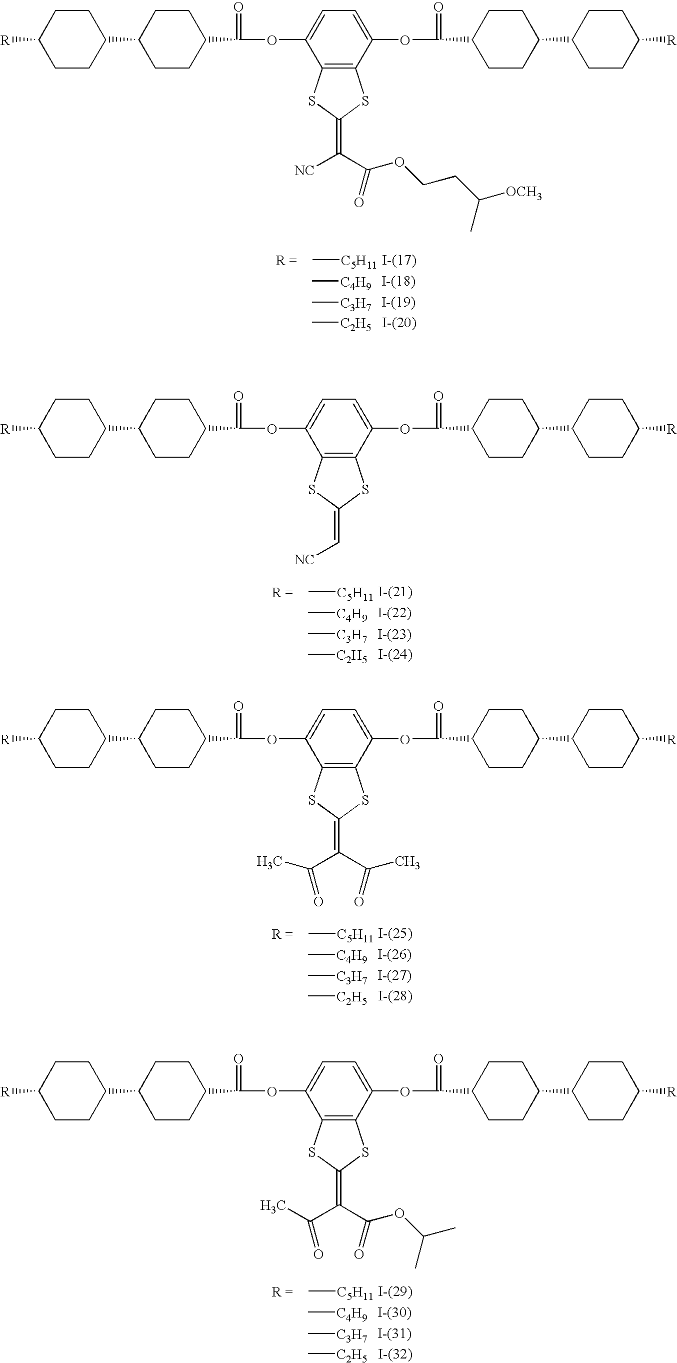

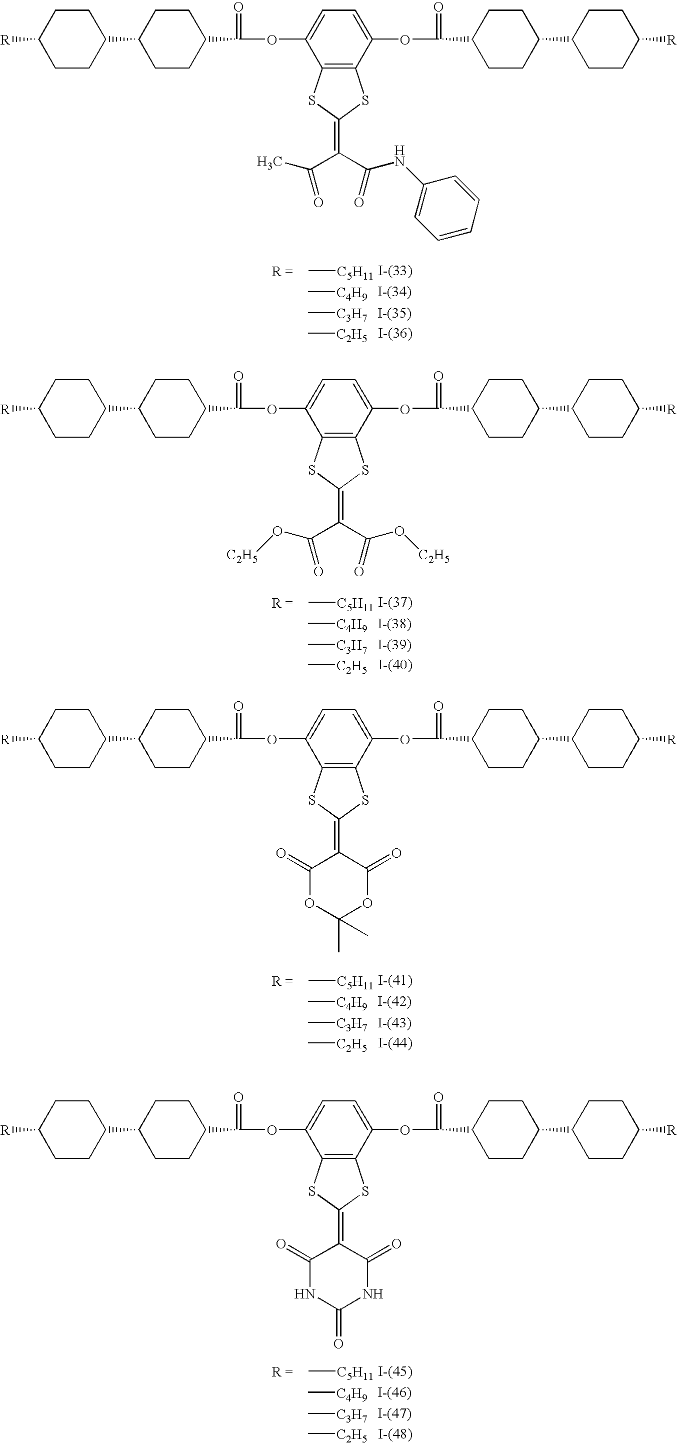

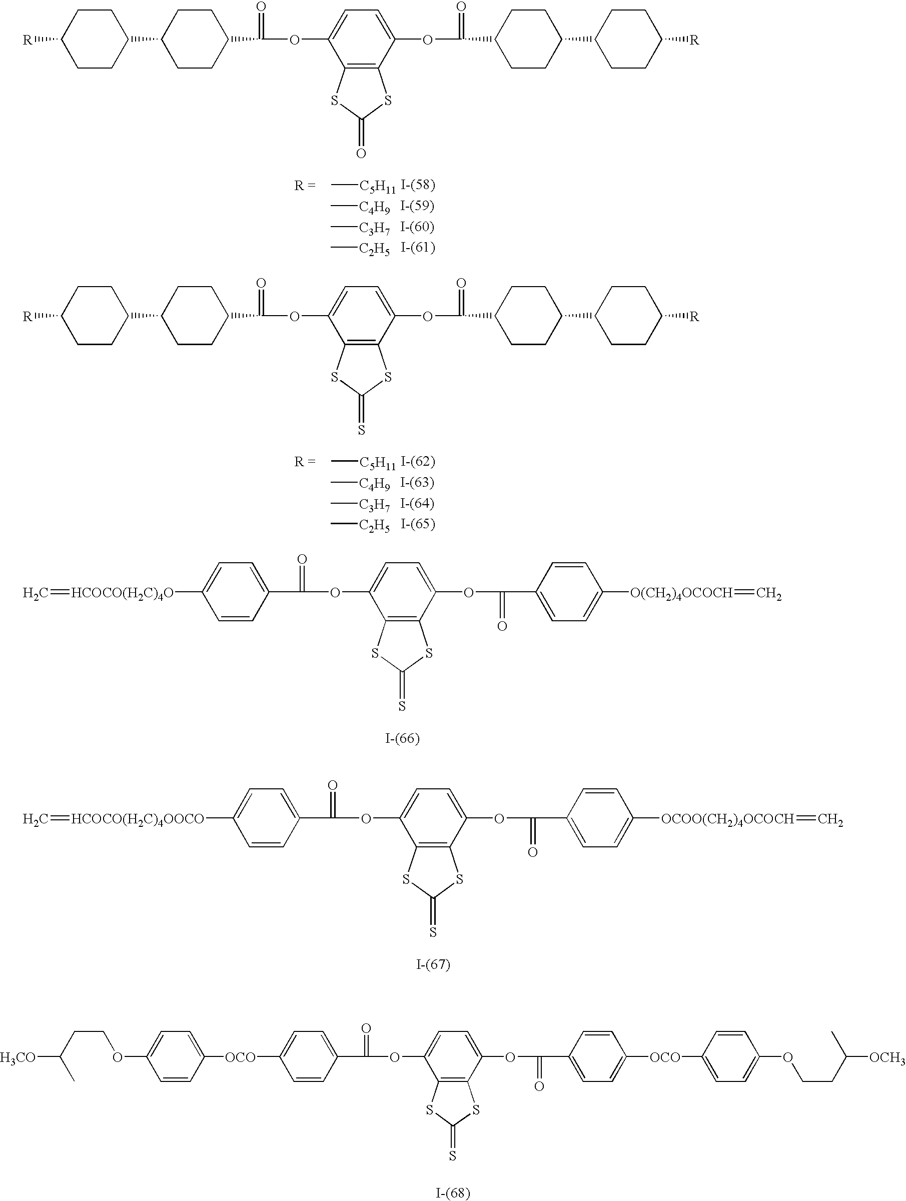

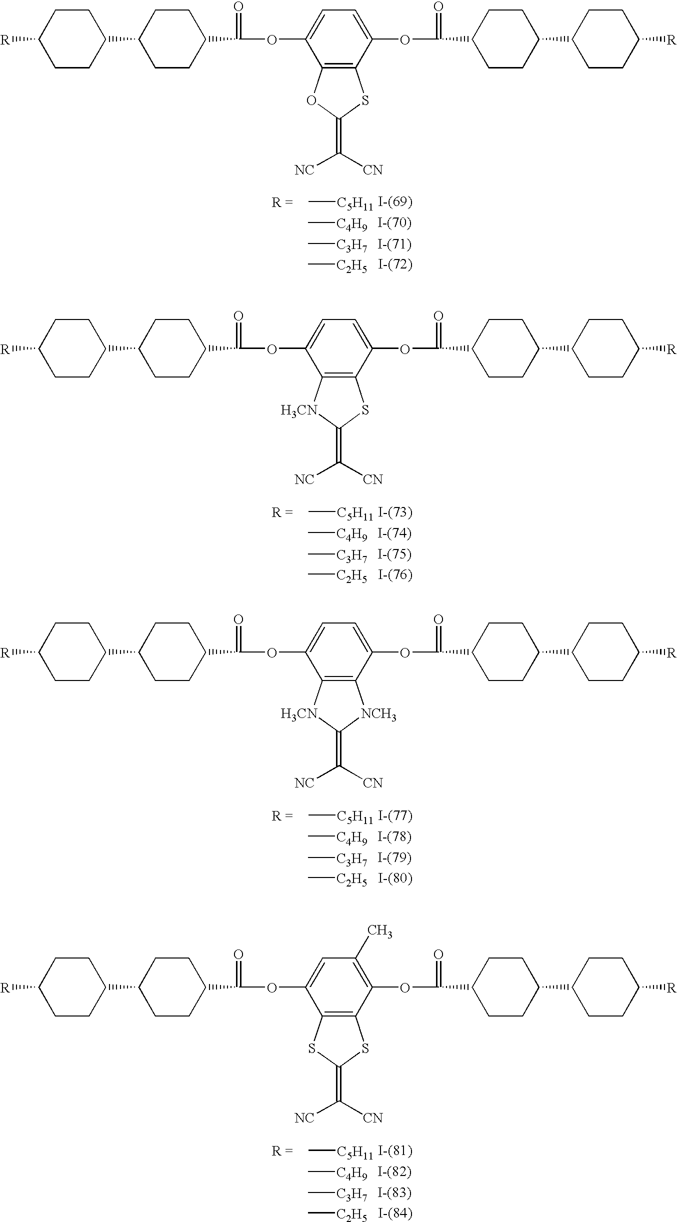

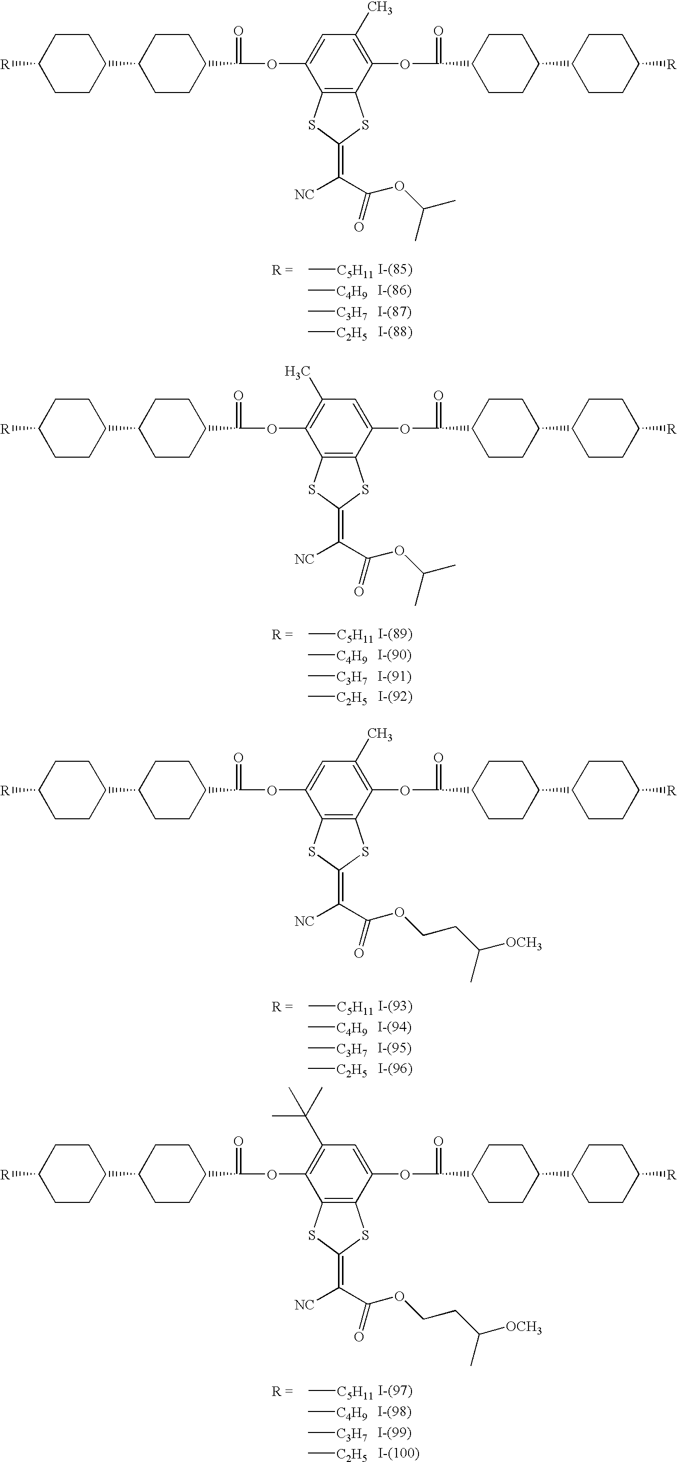

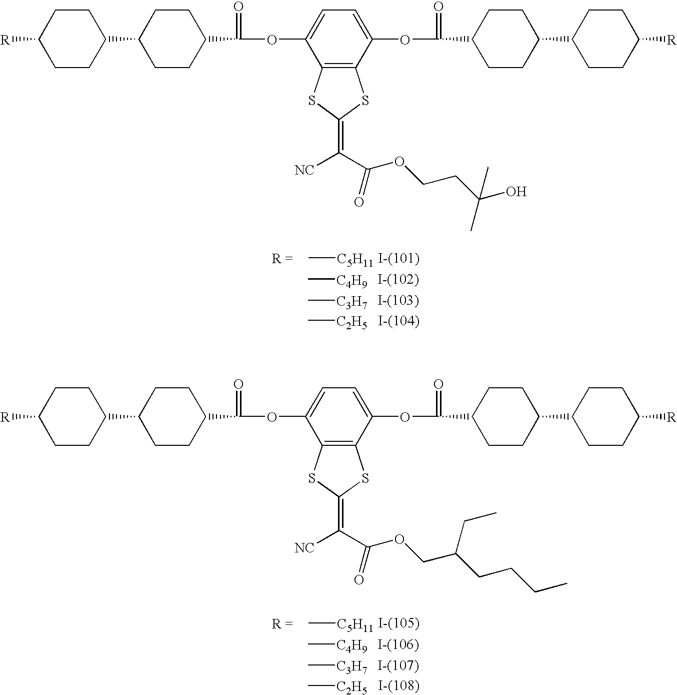

The synthesis of the compound represented by formula (I) or (II) can be performed by referring to a known method. For example, Compound (1) can be synthesized according to the following scheme.

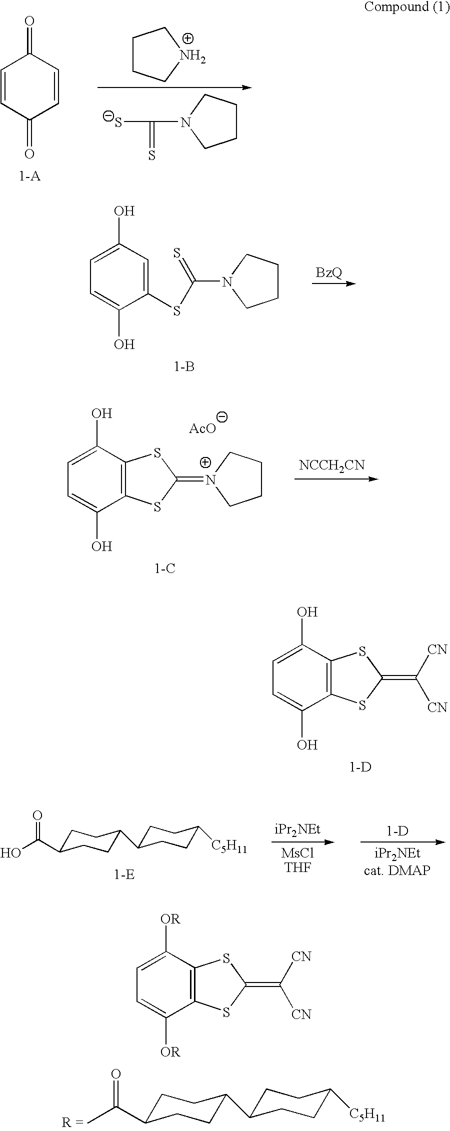

In the scheme above, the synthesis from Compound (1-A) to Compound (1-D) can be performed by referring to the method described in Journal of Chemical Crystallography, pp. 515-526, 27(9) (1997).

Furthermore, as illustrated in the scheme, methanesulfonic acid chloride is added to a tetrahydrofuran solution of Compound (1-E), N,N-diisopropylethylamine is added dropwise, and the solution is then stirred. Subsequently, N,N-diisopropylethylamine is added, a tetrahydrofuran solution of Compound (1-D) is added dropwise, and a tetrahydrofuran solution of N,N-dimethylaminopyridine (DMAP) is then added, whereby Compound (1) can be obtained.

### (Rod-Like Liquid Crystalline Compound)

In the present invention, the rod-like compound indicates a compound having a linear molecular structure. The term “linear molecular structure” means that the molecular structure of the rod-like compound is linear in a thermodynamically most stable configuration. The thermo-dynamically most stable configuration can be determined by the crystal structure analysis or molecular orbital calculation. For example, the molecular orbital calculation is performed using a software program for molecular orbital calculation (e.g., WinMOPAC2000, produced by Fujitsu Ltd.), whereby a molecular structure capable of minimizing the heat of formation of the compound can be determined. The expression “the molecular structure is linear” means that the angle created by the main chain in the molecular structure is 140° or more in the thermodynamically most stable configuration determined by calculation as above.

The rod-like liquid crystalline compound is preferably a compound represented by the following formula (1).

The resin film of the present invention contains a compound represented by formula (1) in an amount of 0.1 to 30 mass %, preferably from 0.5 to 20 mass %, more preferably from 1 to 15 mass %, based on the resin. By virtue of the liquid crystalline compound being the compound represented by formula (1), the retardation developability can be enhanced.

Ar¹-L²-X-L³-Ar² Formula (1)

In formula (1), Ar¹ and Ar² each is independently an aromatic group, L² and L³ each is independently a divalent linking group selected from a —O—CO— group and a —CO—O— group, and X is a 1,4-cyclohexylene group, a vinylene group or an ethynylene group.

In the context of the present invention, the aromatic group includes an aryl group (aromatic hydrocarbon group), a substituted aryl group, an aromatic heterocyclic group and a substituted aromatic heterocyclic group.

The aryl or substituted aryl group is preferred rather than the aromatic heterocyclic group or the substituted aromatic heterocyclic group. The heterocyclic ring in the aromatic heterocyclic group is generally unsaturated. The aromatic heterocyclic ring is preferably a 5-, 6- or 7-membered ring, more preferably a 5- or 6-membered ring. The aromatic heterocyclic ring generally has a largest number of double bonds. The heteroatom is preferably a nitrogen atom, an oxygen atom or a sulfur atom, more preferably a nitrogen atom or a sulfur atom.

The aromatic ring of the aromatic group is preferably a benzene ring, a furan ring, a thiophene ring, a pyrrole ring, an oxazole ring, a thiazole ring, an imidazole ring, a triazole ring, a pyridine ring, a pyrimidine ring or a pyrazine ring, more preferably a benzene ring.

Examples of the substituent for the substituted aryl group and substituted aromatic heterocyclic group include a halogen atom (e.g., F, Cl, Br, I), a hydroxyl group, a carboxyl group, a cyano group, an amino group, an alkylamino group (e.g., methylamino, ethylamino, butylamino, dimethylamino), a nitro group, a sulfo group, a carbamoyl group, an alkylcarbamoyl group (e.g., N-methylcarbamoyl, N-ethylcarbamoyl, N,N-dimethylcarbamoyl), a sulfamoyl group, an alkylsulfamoyl group (e.g., N-methylsulfamoyl, N-ethylsulfamoyl, N,N-dimethylsulfamoyl), a ureido group, an alkylureido group (e.g., N-methylureido, N,N-dimethylureido, N,N,N′-trimethylureido), an alkyl group (e.g., methyl, ethyl, propyl, butyl, pentyl, heptyl, octyl, isopropyl, s-butyl, tert-amyl, cyclohexyl, cyclopentyl), an alkenyl group (e.g., vinyl, allyl, hexenyl), an alkynyl group (e.g., ethynyl, butynyl), an acyl group (e.g., formyl, acetyl, butyryl, hexanoyl, lauryl), an acyloxy group (e.g., acetoxy, butyryloxy, hexanoyloxy, lauryloxy), an alkoxy group (e.g., methoxy, ethoxy, propoxy, butoxy, pentyloxy, heptyloxy, octyloxy), an aryloxy group (e.g., phenoxy), an alkoxycarbonyl group (e.g., methoxycarbonyl, ethoxycarbonyl, propoxycarbonyl, butoxycarbonyl, pentyloxycarbonyl, heptyloxycarbonyl), an aryloxycarbonyl group (e.g., phenoxycarbonyl), an alkoxycarbonylamino group (e.g., butoxycarbonylamino, hexyloxycarbonylamino), an alkylthio group (e.g., methylthio, ethylthio, propylthio, butylthio, pentylthio, heptylthio, octylthio), an arylthio group (e.g., phenylthio), an alkylsulfonyl group (e.g., methylsulfonyl, ethylsulfonyl, propylsulfonyl, butylsulfonyl, pentyl-sulfonyl, heptylsulfonyl, octylsulfonyl), an amido group (e.g., acetamido, butylamido, hexylamido, laurylamido), and a non-aromatic heterocyclic group (e.g., morpholyl, pyrazinyl).

Among the substituents of the substituted aryl group and substituted aromatic heterocyclic group, preferred are a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group.

The alkyl moiety in the alkylamino group, alkoxy-carbonyl group, alkoxy group and alkylthio group, and the alkyl group each may further have a substituent. Examples of the substituent for the alkyl moiety and the alkyl group include a halogen atom, hydroxyl, carboxyl, cyano, amino, an alkylamino group, nitro, sulfo, carbamoyl, an alkylcarbamoyl group, sulfamoyl, an alkylsulfamoyl group, ureido, an alkylureido group, an alkenyl group, an alkynyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. Among the substituents for the alkyl moiety and the alkyl group, preferred are a halogen atom, hydroxyl, amino, an alkylamino group, an acyl group, an acyloxy group, an acylamino group, an alkoxycarbonyl group and an alkoxy group.

In formula (1), L² and L³ each is independently a divalent linking group selected from —O—CO—, —CO—C— and a combination thereof.

In formula (1), X is a 1,4-cyclohexylene group, a vinylene group or an ethynylene group.

Specific examples of the compound represented by formula (1) are set forth below.

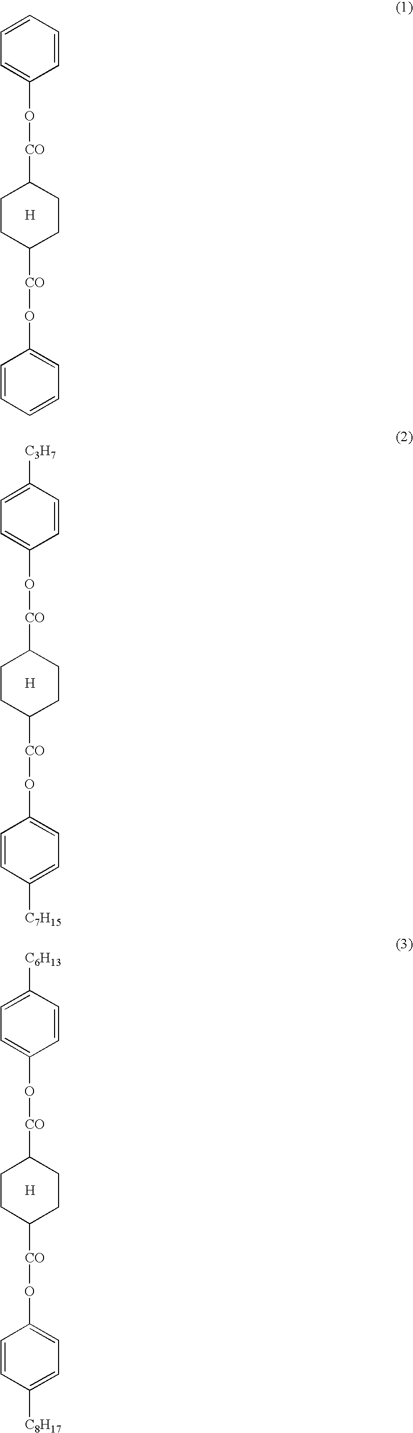

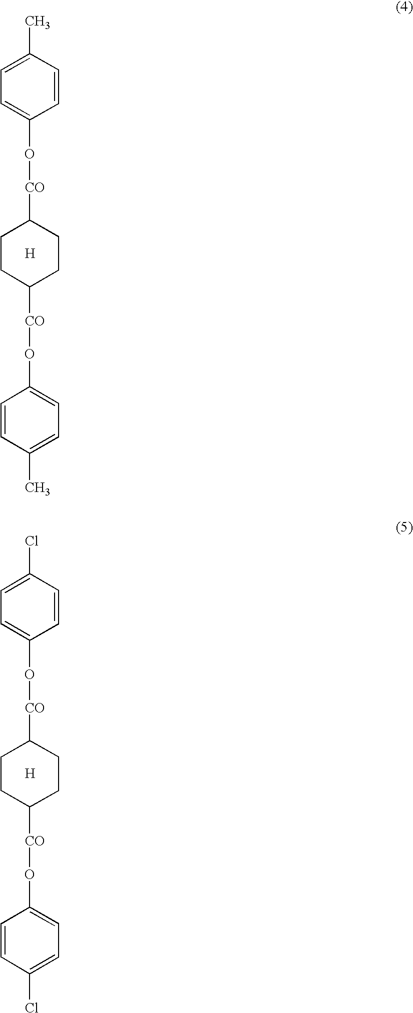

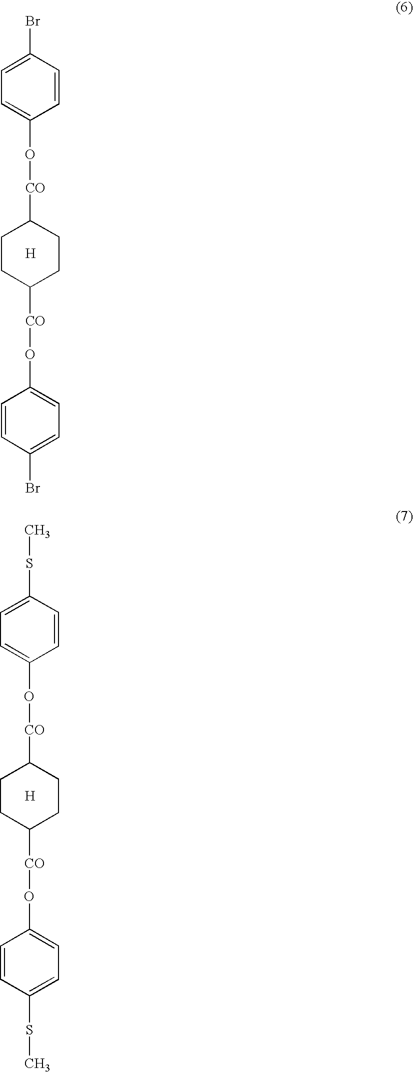

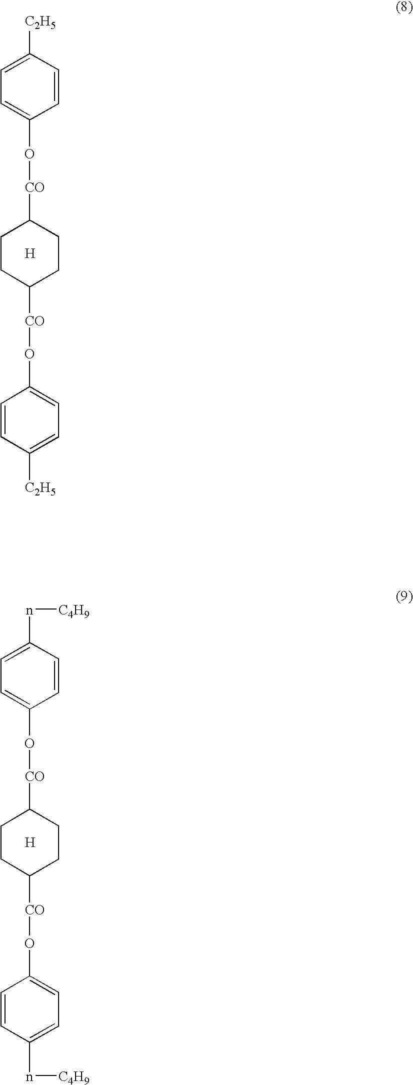

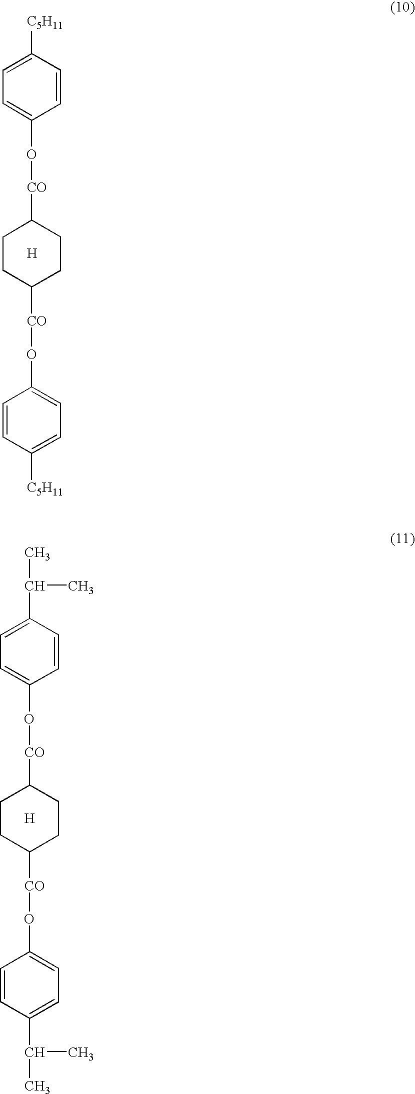

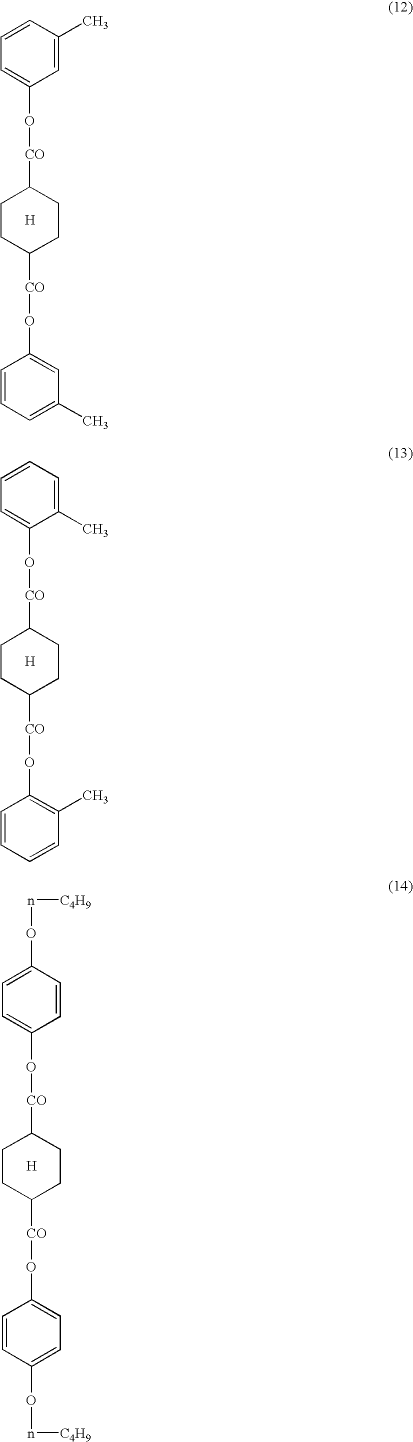

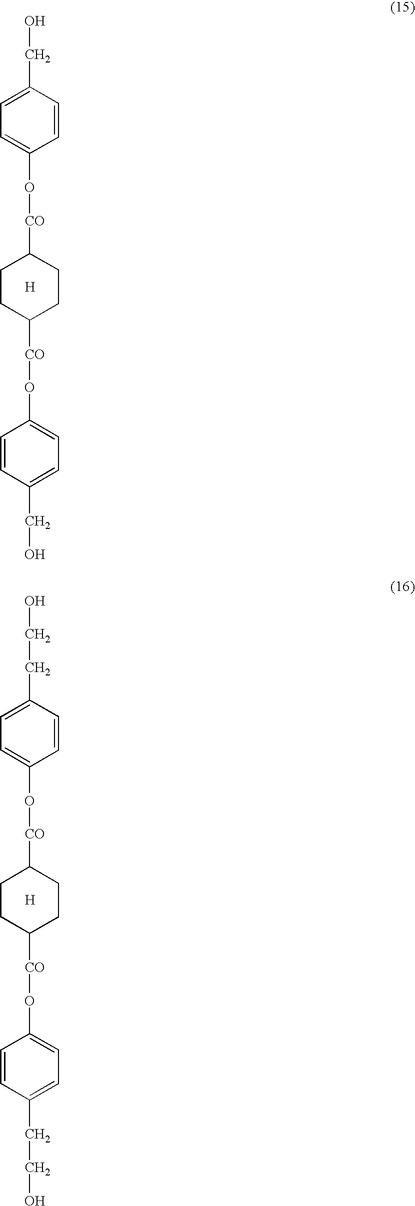

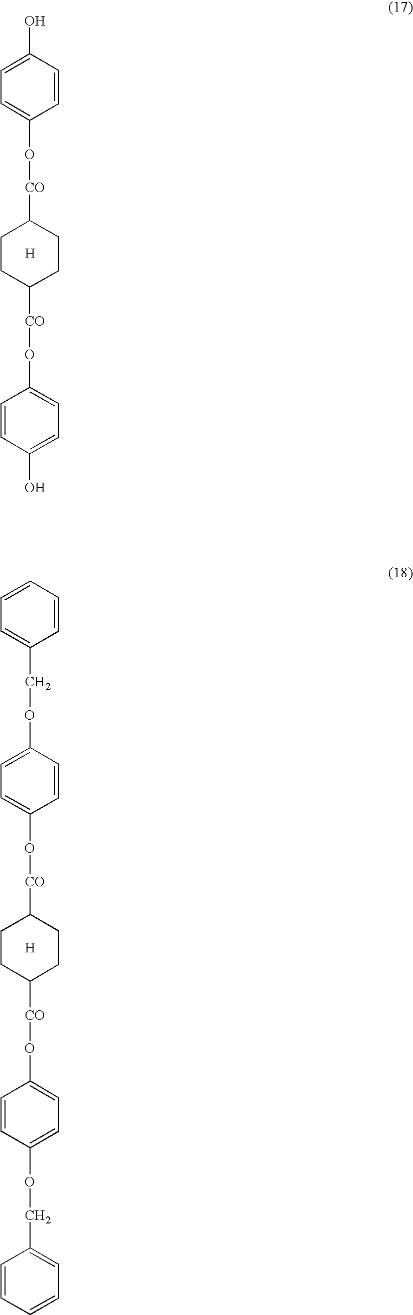

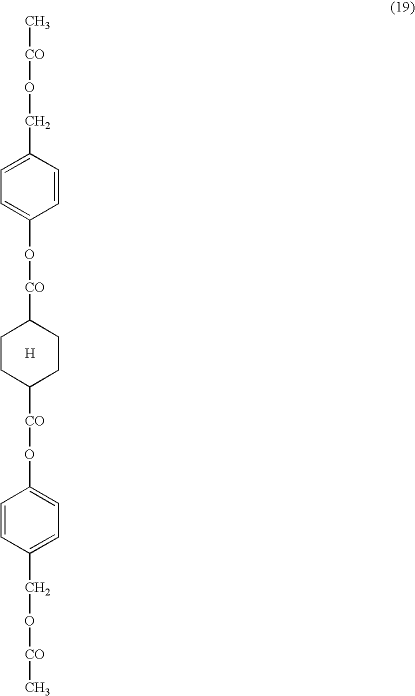

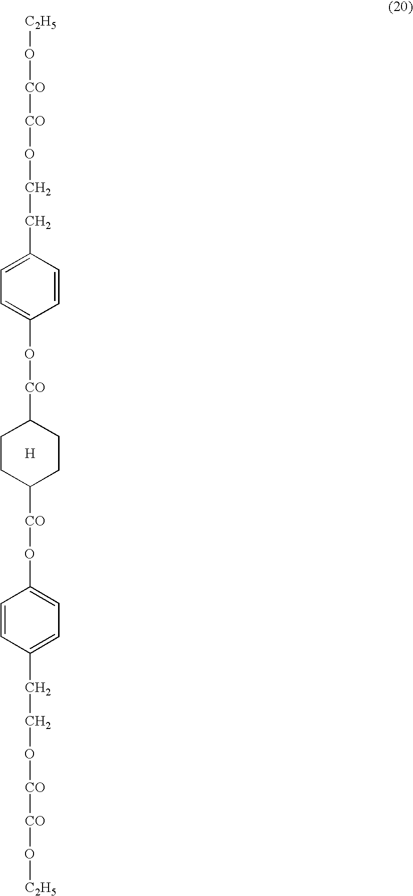

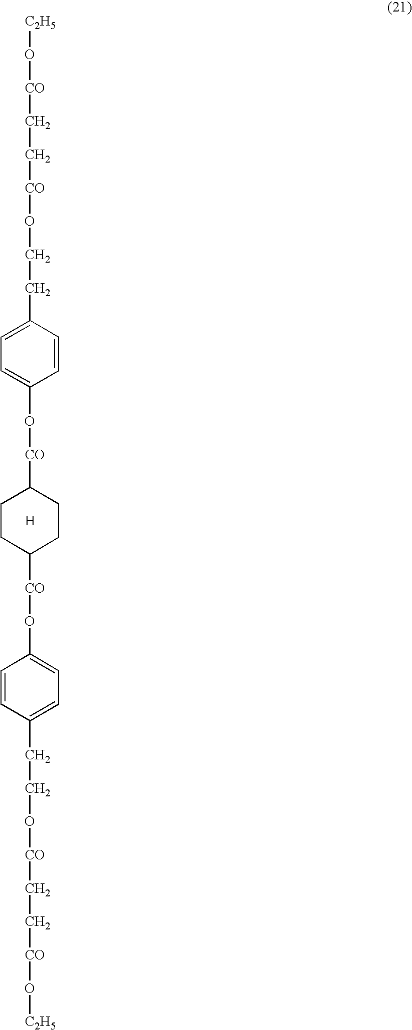

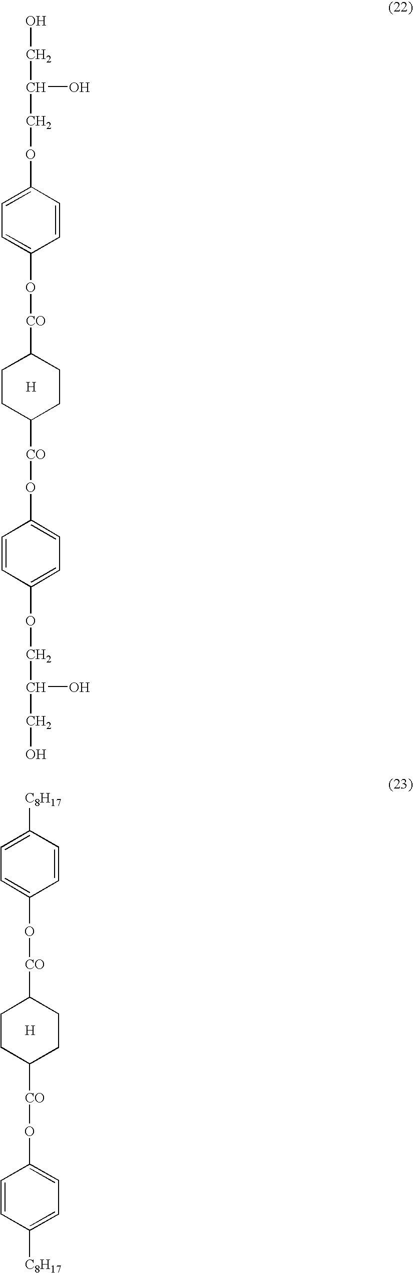

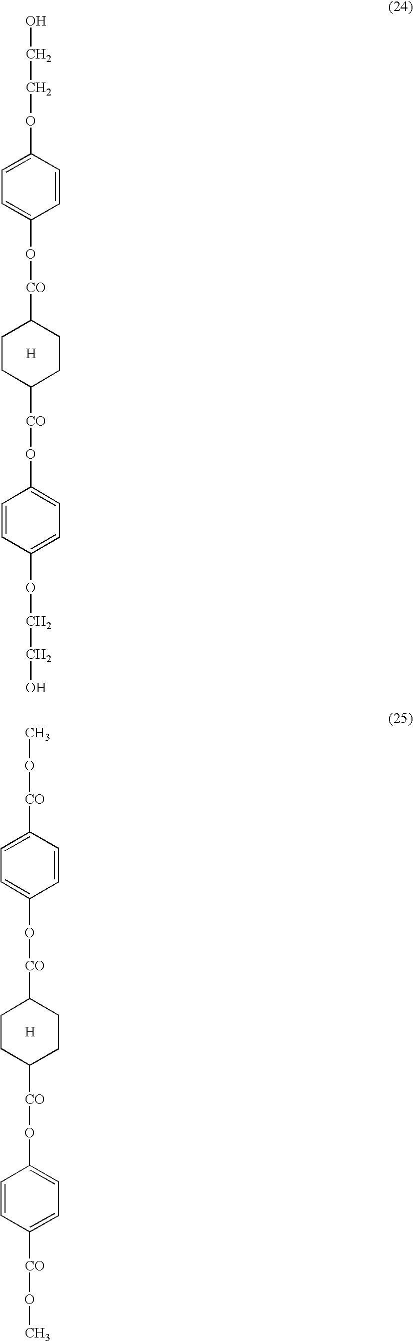

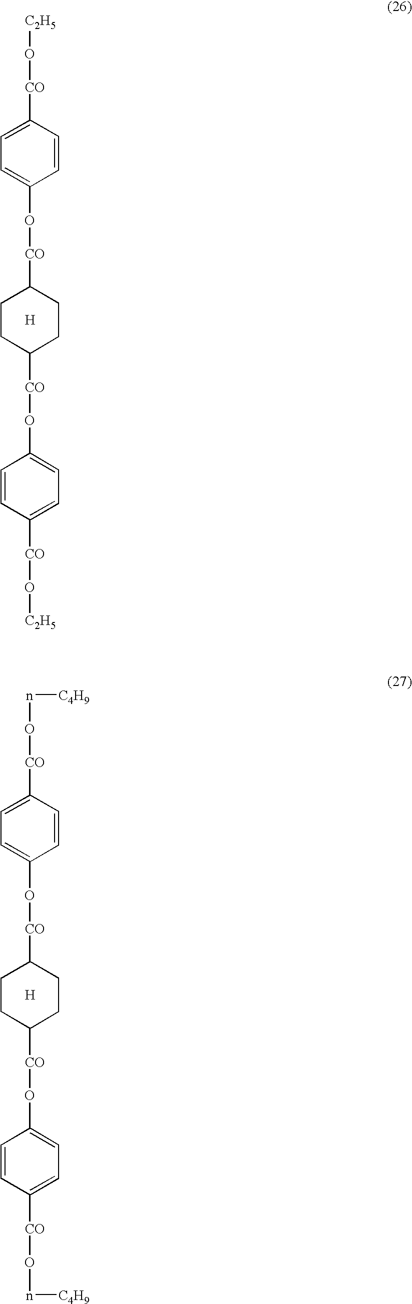

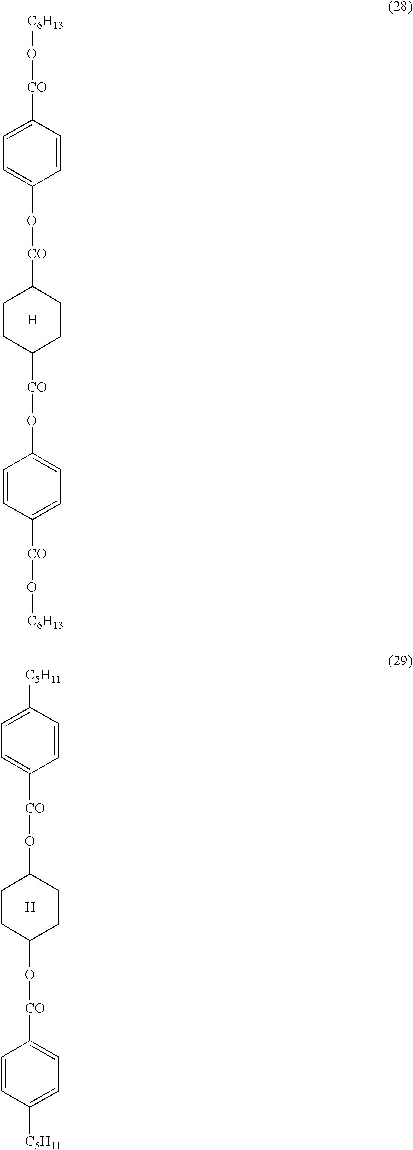

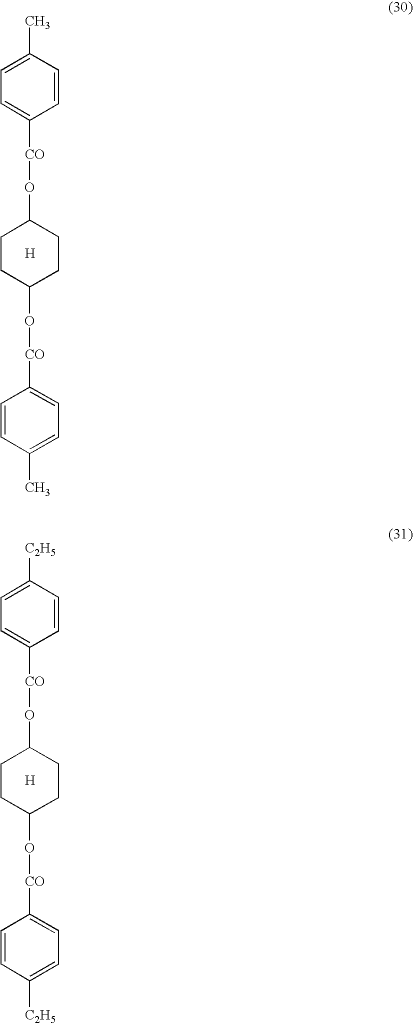

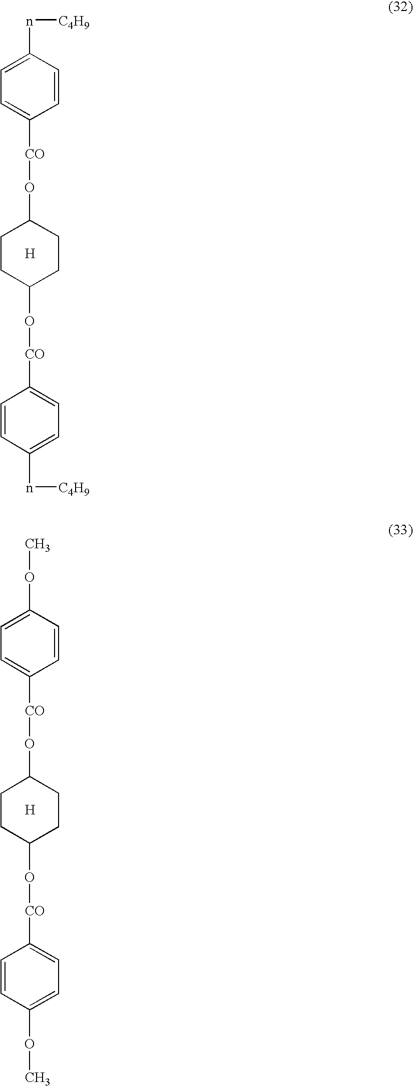

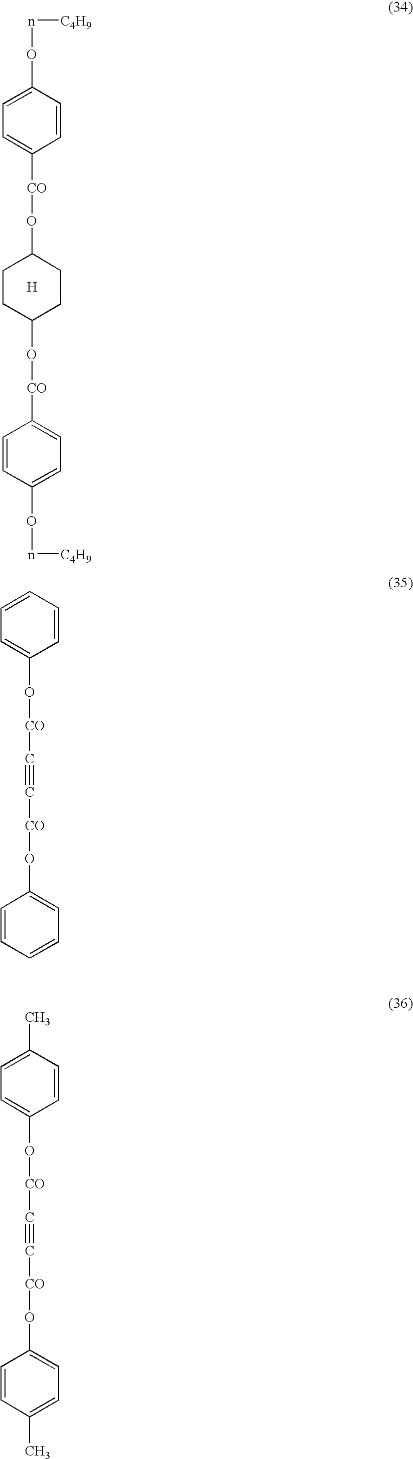

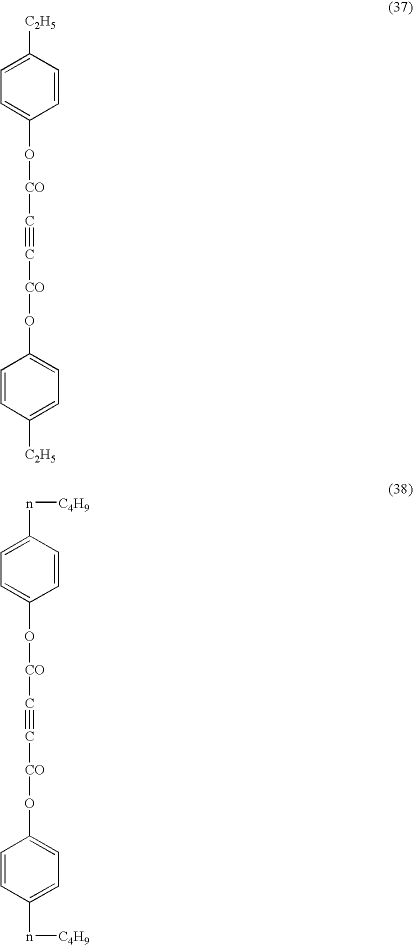

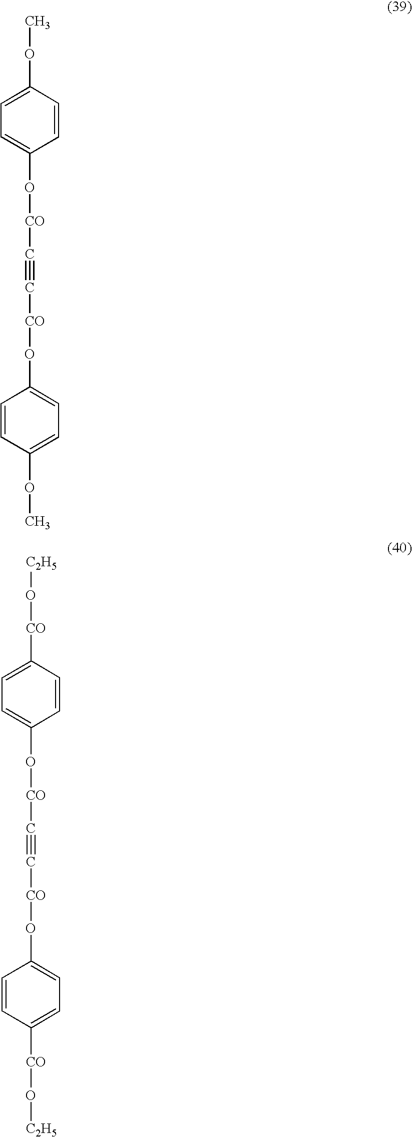

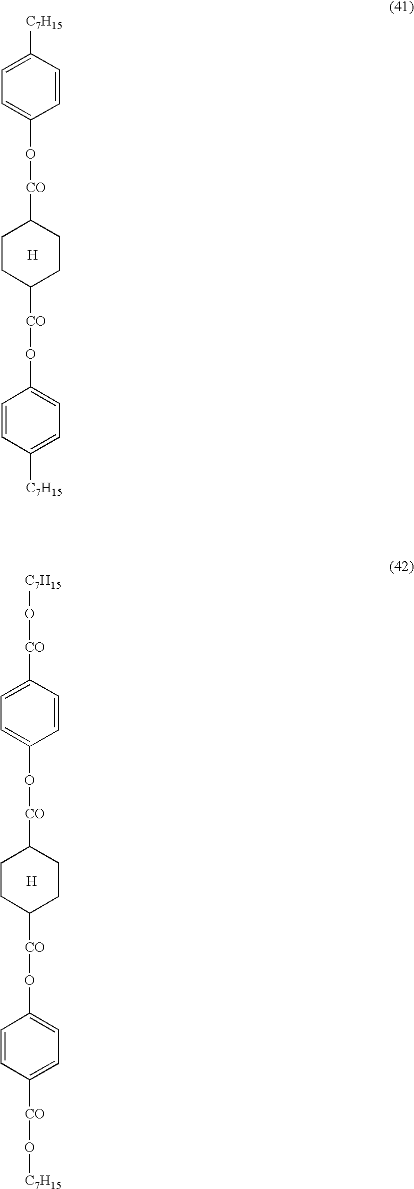

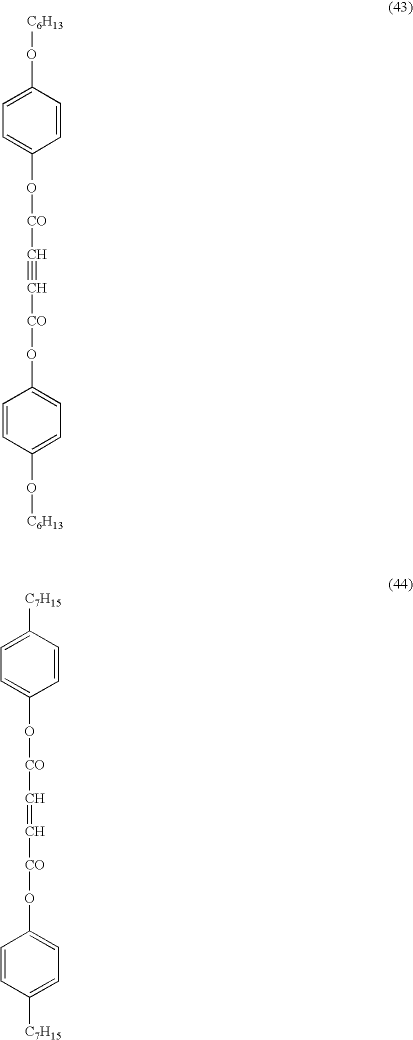

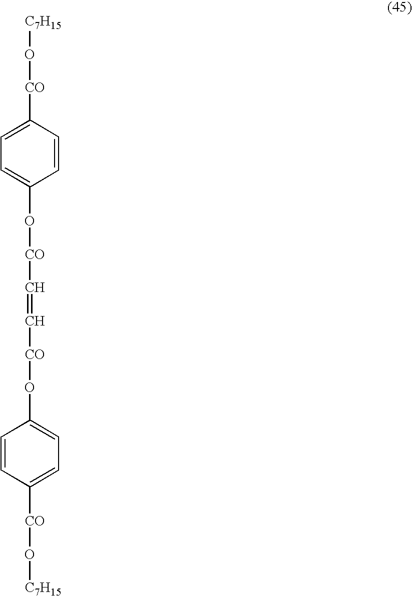

Compounds (1) to (34), (41) and (42) each has two asymmetric carbon atoms at the 1- and 4-positions of the cyclohexane ring. However, since Compounds (1), (4) to (34), (41) and (42) have a symmetrical meso-type molecular structure, these compounds have no optical isomer (optical activity), but only geometric isomers (trans-form and cis-form) are present. The trans-form (1-trans) and cis-form (1-cis) of Compound (1) are shown below.

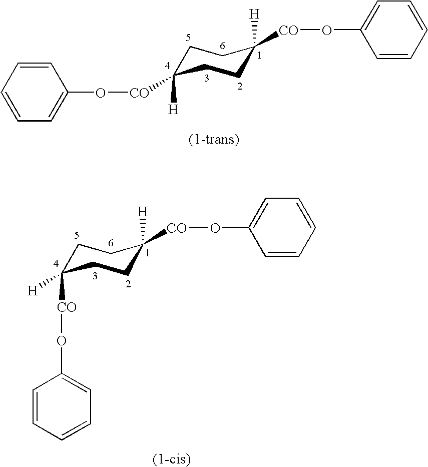

As described above, the rod-like liquid crystalline compound preferably has a linear molecular structure and therefore, a trans-form is preferred rather than a cis-form.

Compounds (2) and (3) each has optical isomers (four isomers in total) in addition to geometric isomers. As for the geometric isomers, a trans-form is similarly preferred rather than a cis-form. The optical isomers have no specific difference in the superiority and may be a D-form, an L-form or a racemic form.

In Compounds (43) to (45), the vinylene bond at the center includes a trans-from and a cis-form. From the same reason as above, a trans-form is preferred rather than a cis-form.

Two or more kinds of rod-like liquid crystalline compounds having a maximum absorption wavelength (λmax) shorter than 250 nm in the ultraviolet absorption spectrum of the solution may be used in combination.

The rod-like liquid crystalline compound can be synthesized by the method described in publications, and the publication includes Mol. Cryst. Liq. Cryst., Vol. 53, page 229 (1979), ibid., Vol. 89, page 93 (1982), ibid., Vol. 145, page 111 (1987), ibid., Vol. 170, page 43 (1989), J. Am. Chem. Soc., Vol. 113, page 1349 (1991), ibid., Vol. 118, page 5346 (1996), ibid., Vol. 92, page 1582 (1970), J. Org. Chem., Vol. 40, page 420 (1975), and Tetrahedron, Vol. 48, No. 16, page 3437 (1992).

As for the liquid crystalline compound used in the present invention, a compound having both a positive intrinsic birefringent component and a negative intrinsic birefringent component (hereinafter sometimes referred to as a “reverse-dispersion liquid crystalline compound”) and a rod-like liquid crystalline compound are preferably used in combination. By using a reverse-dispersion liquid crystalline compound and a rod-like liquid crystalline compound in combination, the retardation developability can be greatly enhanced as compared with the case of using these compounds individually, and the change of retardation due to ambient humidity can be remarkably reduced.

In the present invention, the amount of the liquid crystalline compound added is preferably from 0.1 to 30 parts by mass, more preferably from 0.5 to 20 parts by mass, and most preferably from 1 to 15 parts by mass, per 100 parts by mass of the resin.

In the case of using a reverse-dispersion liquid crystalline compound and a rod-like liquid crystalline compound in combination, the ratio of the rod-like liquid crystalline compound added is preferably from 10 to 1,000 parts by mass, more preferably from 20 to 500 parts by mass, and most preferably from 40 to 200 parts by mass, based on the reverse-dispersion liquid crystalline compound.

By mixing a liquid crystalline compound and a rod-like liquid crystalline compound in the above-described ratio, the temperature range in which a liquid crystal phase appears can be broadened.

In the present invention, as for the method of adding the liquid crystalline compound, the liquid crystalline compound may be added to a cellulose acylate solution (dope) after dissolving the Re developer in an organic solvent such as alcohol, methylene chloride and dioxolan or may be directly added to the dope composition.

The plasticizer for use in the resin film of the present invention is a plasticizer having an octanol/water partition coefficient (logP value) of −2 to 4 and a molecular weight of 200 to 1,400.

The plasticizer for use in the resin film of the present invention is preferably a hydrophilic plasticizer. In the present invention, the hydrophilic plasticizer indicates a plasticizer in which the above-described logP value is 4 or less. The logP value of the hydrophilic plasticizer for use in the present invention is from −2 to 4, preferably from −2 to 3, more preferably from −1.5 to 2.5. If the logP value is too small, the hydrophilic plasticizer seriously dissolves out into a saponification solution when saponifying the resin film and this is not preferred, whereas if it is excessively high, orientation of the liquid crystalline compound is disadvantageously inhibited.

The molecular weight of the hydrophilic plasticizer for use in the present invention is preferably from 250 to 1,400, more preferably from 300 to 1,200. If the molecular weight is too small, the plasticizer readily volatilizes and this is not preferred, whereas if the molecular weight is excessively large, the plasticizer is disadvantageously liable to bleed out when used in combination with a liquid crystalline compound

Also, the molar extinction coefficient of the hydrophilic plasticizer for use in the present invention is preferably 500 or less, more preferably 400 or less, at all wavelengths in the range from 200 to 700 nm. With a molar extinction coefficient in the above-described range, a resin film having large reverse dispersion of retardation is obtained.

The hydrophilic plasticizer for use in the present invention is preferably a carbohydrate derivative, more preferably a monosaccharide or a carbohydrate derivative containing from 2 to 10 monosaccharide units (hereinafter referred to as a “polysaccharide” or a “carbohydrate-based plasticizer”).

The monosaccharide or polysaccharide constituting the carbohydrate-based plasticizer is characterized in that a substitutable group (for example, a hydroxyl group, a carboxyl group, an amino group or a mercapto group) in the molecule is substituted. Examples of the substituent include an ether group, an ester group, an amido group and an imido group.

Examples of the monosaccharide or carbohydrate containing from 2 to 10 monosaccharide units include erythrose, threose, ribose, arabinose, xylose, lyxose, allose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminarabiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, maltopentaose, verbascose, maltohexaose, α-cyclodextrin, β-cyclodextrin, γ-cyclodextrin, δ-cyclodextrin, xylitol and sorbitol.

Among these, preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol and sorbitol, more preferred are arabinose, xylose, glucose, fructose, mannose, galactose, maltose, cellobiose, sucrose, β-cyclodextrin, γ-cyclodextrin, and still more preferred are xylose, glucose, fructose, mannose, galactose, maltose, cellobiose, sucrose, xylitol and sorbitol.

Examples of the substituent of the carbohydrate-based plasticizer include an ether group (preferably an alkyl ether group having a carbon number of 1 to 22, more preferably from 1 to 12, still more preferably from 1 to 8, e.g., methyl ether, ethyl ether, propyl ether, hydroxyethyl ether, hydroxypropyl ether, 2-cyanoethyl ether), an ester group (preferably an acyl ester group having a carbon number of 1 to 22, more preferably from 2 to 12, still more preferably from 2 to 8, e.g., acetyl, propionyl, butyryl, pentanoyl, hexanoyl, octanoyl), an amido group (preferably an amido having a carbon number of 1 to 22, more preferably from 2 to 12, still more preferably from 2 to 8, e.g., formamido, actamido), and an imido group (preferably an imido group having a carbon number of 4 to 22, more preferably from 4 to 12, still more preferably from 4 to 8, e.g., succinimido).

Among these, preferred are an ether group and an ester group, and more preferred is an ester group.

Preferred examples of the carbohydrate-based plasticizer include the followings, but the carbohydrate-based plasticizer which can be used in the present invention is not limited thereto.

That is, preferred examples include xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, sorbitol hexapropionate, xylose tetrabutyrate, glucose pentabutyrate, fructose pentabutyrate, mannose pentabutyrate, galactose pentabutyrate, maltose octabutyrate, cellobiose octabutyrate, sucrose octabutyrate, xylitol pentabutyrate, sorbitol hexabutyrate. Among these, more preferred are xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate and sorbitol hexapropionate

The carbohydrate-based plasticizer for use in the present invention preferably has a pyranose structure or a furanose structure, more preferably a pyranose structure.

The carbohydrate-based plasticizer for use in the present invention is available as a commercial product (for example, available from Tokyo Kasei Kogyo Co., Ltd. or Aldrich) or may be synthesized by processing a commercially available carbohydrate into an ester derivative by a known method (for example, the method described in JP-A-8-245678).

In the present invention, one kind of a carbohydrate-based plasticizer may be blended alone, or two or more kinds thereof may be used in combination. Also, the carbohydrate-based plasticizer may be used in combination with other plasticizers. Preferred examples of other plasticizers include carboxylic acid esters and fatty acid esters of polyhydric alcohol.

The amount of the plasticizer added is preferably from 1 to 20 mass % based on the polymer resin. When the amount added is 1 mass % or more, the effect of accelerating the orientation of the liquid crystalline compound is easily obtained, and when the amount added is 20 mass % or less, bleed-out is scarcely caused. The amount added is more preferably from 2 to 15 mass %, and most preferably from 3 to 10 mass %.

The timing of adding the plasticizer to the resin film is not particularly limited as long as it is already added at the film formation. For example, the plasticizer may be added at the synthesis of a resin polymer or may be mixed with a polymer resin at the preparation of a dope.

### [Matrix Resin]

As regards the polymer resin for use in the present invention, a norbornene-based polymer, a cellulose acylate-based polymer, a polyvinyl alcohol derivative polymer, an aliphatic polycarbonate-based polymer and the like may be preferably used. Among these, a cellulose acylate-based polymer is preferred, because this polymer has both a positive intrinsic birefringence component and a negative intrinsic birefringence component and is assured of small photoelastic coefficient and high affinity for a polyvinyl alcohol used in the polarizer.

The resin film of the present invention preferably contains 50 mass % or more of a cellulose acylate as the resin.

The cellulose acylate for use in the present invention is described in detail below.

### [Cellulose Acylate]

The substitution degree of a cellulose acylate means a proportion at which three hydroxyl groups present in the cellulose constituent unit ((β)1,4-glycoside-bonded glucose) are acylated. The substitution degree (acylation degree) can be calculated by measuring the amount of a fatty acid bonded per the mass of the cellulose constituent unit. In the present invention, the substitution degree of a cellulose form can be calculated by C¹³-NMR measurement after substituting the residual hydroxyl group of a cellulose acylate by another acyl group different from the acyl group in the cellulose acylate itself. Details of the measuring method are described in Tezuka et al., Carbohydrate Res., 273, 83-91 (1995).

The cellulose acylate for use in the present invention is preferably a cellulose acetate having an acylation degree of 2.00 to 2.98. The acylation degree is more preferably from 2.70 to 2.97, and most preferably from 2.86 to 2.97. The ratio of the acylation degree at the 6-position to the entire acylation degree is preferably 0.25 or more, more preferably 0.3 or more.

In the present invention, another preferred cellulose acylate is a mixed fatty acid ester having an acylation degree of 2 to 2.95 and containing an acetyl group and an acyl group having a carbon number of 3 to 4. The acylation degree of the mixed fatty acid ester is more preferably from 2.2 to 2.85, and most preferably from 2.3 to 2.8. Also, the acetylation degree is preferably less than 2.5, more preferably less than 1.9.

In the present invention, those two kinds of cellulose acylates may be used in combination and mixed, and a film comprising a plurality of layers composed of different cellulose acylates may be formed, for example, by a co-casting method described later.

Furthermore, the mixed acid ester having a fatty acid acyl group and a substituted or unsubstituted aromatic acyl group described in paragraphs 23 to 38 of JP-A-2008-20896 may also be preferably used in the present invention.

The cellulose acylate for use in the present invention preferably has a mass average polymerization degree of 250 to 800, more preferably from 300 to 600. Also, the cellulose acylate for use in the present invention preferably has a number average molecular weight of 70,000 to 230,000, more preferably from 75,000 to 230,000, and most preferably from 78,000 to 120,000.

The cellulose acylate for use in the present invention can be synthesized using an acid anhydride or an acid chloride as the acylating agent. In the case where the acylating agent is an acid anhydride, an organic acid (e.g., acetic acid) or methylene chloride is used as the reaction solvent. Also, a protonic catalyst such as sulfuric acid may be used as the catalyst. In the case where the acylating agent is an acid chloride, a basic compound can be used as the catalyst. In a synthetic method most commonly employed in industry, a cellulose ester is synthesized by esterifying a cellulose with a mixed organic acid component containing an acetyl group and an organic acid (acetic acid, propionic acid, butyric acid) corresponding to other acyl group, or its acid anhydride (acetic anhydride, propionic anhydride, butyric anhydride).

In the above-described method, a cellulose such as cotton linter or wood pulp is in many cases subjected to an activation treatment with an organic acid such as acetic acid and then to esterification using a mixed solution of organic acid components described above in the presence of a sulfuric acid catalyst. The organic acid anhydride component is generally used in an excess amount with respect to the amount of the hydroxyl group present in the cellulose. In the esterification treatment, a hydrolysis reaction (depolymerization reaction) of the cellulose main chain ((β)-1,4-glycoside bond) proceeds in addition to an esterification reaction. If the hydrolysis reaction of the main chain proceeds, the polymerization degree of the cellulose ester decreases and the physical properties of the produced cellulose ester film are deteriorated. Accordingly, the reaction conditions such as reaction temperature are preferably determined by taking into consideration the polymerization degree or molecular weight of the cellulose ester obtained.

### [Production of Cellulose Acylate Film]

The cellulose acylate film of the present invention can be produced by a solvent casting method. In the solvent casting method, the film is produced using a solution (dope) prepared by dissolving a cellulose acylate in an organic solvent.

The organic solvent preferably contains a solvent selected from an ether having a carbon number of 3 to 12, a ketone having a carbon number of 3 to 12, an ester having a carbon number of 3 to 12, and a halogenated hydrocarbon having a carbon number of 1 to 6.

The ether, ketone and ester each may have a cyclic structure. A compound having any two or more functional groups of the ester, ketone and ether (that is, —O—, —CO— and —COO—) may also be used as the organic solvent. The organic solvent may have another functional group such as alcoholic hydroxyl group. In the case of an organic solvent having two or more kinds of functional groups, the number of carbon atoms is preferably within the preferred range specified above for the solvent having any one functional group.

Examples of the ethers having a carbon number of 3 to 12 include diisopropyl ether, dimethoxymethane, dimethoxy-ethane, 1,4-dioxane, 1,3-dioxolan, tetrahydrofuran, anisole and phenetol.

Examples of the ketones having a carbon number of 3 to 12 include acetone, methyl ethyl ketone, diethyl ketone, diisobutyl ketone, cyclohexanone and methylcyclohexanone.

Examples of the esters having a carbon number of 3 to 12 include ethyl formate, propyl formate, pentyl formate, methyl acetate, ethyl acetate and pentyl acetate.

Examples of the organic solvent having two or more kinds of functional groups include 2-ethoxyethyl acetate, 2-methoxyethanol and 2-butoxyethanol.

The number of carbon atoms in the halogenated hydrocarbon having a carbon number of 1 to 6 is preferably 1 or 2, and most preferably 1. The halogen of the halogenated hydrocarbon is preferably chlorine. The proportion at which the hydrogen atom of the hydrogenated hydrocarbon is substituted by a halogen is preferably from 25 to 75 mol %, more preferably from 30 to 70 mol %, still more preferably from 35 to 65 mol %, and most preferably from 40 to 60 mol %. A representative halogenated hydro-carbon is methylene chloride.

Two or more kinds of organic solvents may be mixed and used.

A cellulose acylate solution (dope) can be prepared by a general method of performing a treatment at a temperature of 0° C. or more (ordinary temperature or high temperature). The preparation of the cellulose acylate solution can be performed using a method and an apparatus for dope preparation in the general solvent casting method. In the case of a general method, a halogenated hydrocarbon (particularly, methylene chloride) is preferably used as the organic solvent.

The amount of the cellulose acylate in the cellulose acylate solution is adjusted to occupy from 10 to 40 mass % in the solution obtained. The amount of the cellulose acylate is preferably from 10 to 30 mass %. An arbitrary additive described later may be previously added in the organic solvent (main solvent).

A cellulose acylate solution can be prepared by stirring a cellulose acylate and an organic solvent at an ordinary temperature (from 0 to 40° C.). A solution in a high concentration may be stirred under pressure in a heating condition. Specifically, a cellulose acylate and an organic solvent are charged into a pressure vessel and after sealing the vessel, the mixture is stirred under pressure while heating at a temperature in the range from a temperature not less than the boiling point of the solvent at ordinary temperature to a temperature not allowing for boiling of the solvent. The heating temperature is usually 40° C. or more, preferably from 60 to 200° C., more preferably from 80 to 110° C.

The components may be roughly mixed in advance and then charged into a vessel or may be successively charged into the vessel. The vessel needs to be constructed so that stirring can be performed. The vessel can be pressurized by injecting an inert gas such as nitrogen gas. Also, the rise in vapor pressure of the solvent due to heating may be utilized. Alternatively, the components may be added under pressure after sealing the vessel.

In the case of performing heating, the heating is preferably applied from outside of the vessel. For example, a jacket-type heating device may be used. Also, the entire vessel may be heated by providing a plate heater outside the vessel, laying a piping system and circulating a liquid.

The stirring is preferably performed using a stirring blade by providing the stirring blade inside the vessel. A stirring blade having a length long enough to reach near the wall of the vessel is preferred. The tip of the stirring blade is preferably equipped with a scraping blade for renewing the liquid film on the wall of the vessel.

The vessel may be equipped with measuring meters such as pressure gauge and thermometer. Each component is dissolved in a solvent inside of the vessel. The dope prepared is cooled and then taken out of the vessel, or the dope is taken out of the vessel and then cooled using a heat exchanger or the like.

The cellulose acylate solution may also be prepared by a cooling dissolution method. As for details of the cooling dissolution method, the techniques described in to [0122] of JP-A-2007-86748 may be employed.

A cellulose acylate film is produced from the prepared cellulose acylate solution (dope) by a solvent casting method. A retardation developer is preferably added to the dope. The dope is cast on a drum or a band, and the solvent is evaporated to form a film. The concentration of the dope before casting is preferably adjusted to have a solid content of 18 to 35%. The surface of the drum or band is preferably finished in a mirror state. The dope is preferably cast on a drum or band at a surface temperature of 10° C. or less.

The drying method in the solvent casting method is described in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (the term “JP-B” as used herein means an “examined Japanese patent publication”), JP-B-49-5614, JP-A-60-176834, JP-A-60-203430, and JP-A-62-115035. Drying on the band or drum can be performed by blowing air or an inert gas such as nitrogen.

The obtained film is separated from the drum or band and may be further dried with hot air by sequentially changing the temperature from 100° C. to 160° C. to evaporate the residual solvent. This method is described in JP-B-5-17844. According to this method, the time from casting to separation can be shortened. In order to practice this method, the dope needs to be gelled at the surface temperature of the drum or band during casting.

A film may also be formed by casting the prepared cellulose acetate solution (dope) in two or more layers. In this case, the cellulose acylate film is preferably produced by a solvent casting method. The dope is cast on a drum or a band and the solvent is evaporated to form a film. The concentration of the dope before casting is preferably adjusted to have a solid content of 10 to 40 mass %. The surface of the drum or band is preferably finished in a mirror state.

In the case of casting the cellulose acetate solution in a plurality of layers of two or more layers, a plurality of cellulose acetate solutions can be cast, and the cellulose acylate-containing solutions may be respectively cast from a plurality of casting ports provided with spacing in the support travelling direction to form a film while stacking layers one on another. This casting can be performed using the method described, for example, in JP-A-61-158414, JP-A-1-122419 and JP-A-11-198285. Also, the cellulose acetate solution may be cast from two casting ports to form a film, and the method described, for example, in JP-B-60-27562, JP-A-61-94724, JP-A-61-947245, JP-A-61-104813, JP-A-61-158413 and JP-A-6-134933 may be used therefor. Furthermore, a cellulose acylate film casting method described in JP-A-56-162617 of encompassing the flow of a high-viscosity cellulose acylate solution with a low-viscosity cellulose acylate solution and simultaneously extruding the high-viscosity and low-viscosity cellulose acylate solutions may also be used.

In addition, the film can also be produced using two casting ports by separating the film cast from a first casting dye and formed on a support and performing a second casting on the side which had been in contact with the support surface. For example, the method described in JP-B-44-20235 may be used.

The cellulose acylate solutions cast may be the same solution, or two or more different cellulose acylate solutions may be used. In order to impart a function to a plurality of cellulose acylate layers, a cellulose acylate solution according to the function may be extruded from each casting port. The cellulose acylate solution for use in the present invention may also be cast simultaneously with other functional layers (for example, adhesive layer, dye layer, antistatic layer, antihalation layer, ultra-violet absorbing layer and polarizing layer).

Many of conventional single-layer solutions have a problem that a high-viscosity cellulose acylate solution in a high concentration must be extruded so as to obtain a required film thickness and in this case, the cellulose acylate solution has bad stability to produce a solid material, giving rise to particle failure or poor planarity. For solving this problem, when a plurality of cellulose acylate solutions are cast from casting ports, high-viscosity solutions can be simultaneously extruded on the support and not only the planarity can be improved to allow for production of a film having excellent surface state but also reduction in the drying load can be achieved by virtue of use of a thick cellulose acylate solution to thereby raise the production speed of the film.

In the cellulose acylate film, a deterioration inhibitor (e.g., antioxidant, peroxide decomposer, radical inhibitor, metal deactivator, acid scavenger, amine) may be added. The deterioration inhibitor is described in JP-A-3-199201, JP-A-5-1907073, JP-A-5-194789, JP-A-5-271471 and JP-A-6-107854. The amount of the deterioration inhibitor added is preferably from 0.01 to 1 mass %, more preferably from 0.01 to 0.2 mass %, based on the solution (dope) prepared. When the amount added is 0.01 mass % or more, the effect of the deterioration inhibitor can be satisfactorily brought out and this is preferred, and when the amount added is 1 mass % or less, bleed-out (leaching) of the deterioration inhibitor to the film surface is advantageously less caused. Preferred examples of the deterioration inhibitor include butylated hydroxytoluene (BHT) and tribenzylamine (TBA).

In the cellulose acylate film, a fine particle is preferably added as a matting agent. Examples of the fine particle for use in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Among these, a fine particle containing silicon is preferred in view of giving low turbidity, and silicon dioxide is more preferred. The fine silicon dioxide particle is preferably a fine particle having an average primary particle diameter of 20 nm or less and an apparent specific gravity of 70 g/liter or more. The apparent specific gravity is preferably from 90 to 200 g/liter or more, more preferably from 100 to 200 g/liter or more. As the apparent specific gravity is larger, a liquid dispersion having a higher concentration can be prepared and this is preferred in view of haze and aggregate.

Such fine particles usually form a secondary particle having an average particle diameter of 0.1 to 3.0 μm and in the film, this fine particle is present as an aggregate of primary particles to form irregularities of 0.1 to 3.0 μm on the film surface. The average secondary particle diameter is preferably from 0.2 to 1.5 μm, more preferably from 0.4 to 1.2 μm, and most preferably from 0.6 to 1.1 μm. With respect to the primary and secondary particle diameters, particles in the film are observed through a scanning electron microscope, and the diameter of a circle circumscribing a particle is defined as the particle diameter. Also, 200 particles are observed by changing the site and the average value thereof is defined as the average particle diameter.

The fine silicon dioxide particle used may be a commercially available product such as Aerosil R972, R972V, R974, R812, 200, 200V, 300, R202, OX50 and TT600 (all produced by Nihon Aerosil Co., Ltd.). The fine zirconium oxide particle is commercially available under the trade name of, for example, Aerosil R976 or R811 (both produced by Nihon Aerosil Co., Ltd.), and these may be used.

Among these, Aerosil 200V and Aerosil R972V are preferred because these are a fine silicon dioxide particle having an average primary particle diameter of 20 nm or less and an apparent specific gravity of 70 g/liter or more and provide a high effect of decreasing the coefficient of friction while maintaining low turbidity of the optical film.

In the present invention, in order to obtain a cellulose acylate film containing a particle having a small average secondary particle diameter, several techniques may be employed at the preparation of a fine particle liquid dispersion. For example, in one method, a solvent and a fine particle are mixed with stirring to previously prepare a fine particle liquid dispersion, the obtained fine particle liquid dispersion is added to a small amount of a separately prepared cellulose acylate solution and then dissolved with stirring, and the resulting solution is further mixed with a main cellulose acylate solution (dope solution). This preparation method is preferred in that good dispersibility of the fine silicone dioxide particle is ensured and re-aggregation of fine silicon dioxide particles scarcely occurs. In another method, a small amount of a cellulose acylate is added to a solvent and then dissolved with stirring, a fine particle is added thereto and dispersed by a disperser to obtain a fine particle-added solution, and the fine particle-added solution is thoroughly mixed with a dope solution by an in-line mixer. The present invention is not limited to these methods, but at the time of mixing and dispersing the fine silicon dioxide particle with a solvent or the like, the concentration of silicon dioxide is preferably from 5 to 30 mass %, more preferably from 10 to 25 mass %, and most preferably from 15 to 20 mass %. A higher dispersion concentration is preferred because the liquid turbidity for the amount added becomes low and the haze and aggregate are improved. In the final dope solution of cellulose acylate, the amount of the matting agent fine particle added is preferably from 0.01 to 1.0 g/m³, more preferably from 0.03 to 0.3 g/m³, and most preferably from 0.08 to 0.16 g/m³.

As for the solvent used here, preferred examples of the lower alcohols include methyl alcohol, ethyl alcohol, propyl alcohol, isopropyl alcohol and butyl alcohol. The solvent other than the lower alcohol is not particularly limited, but the solvent used at the film formation of a cellulose ester is preferably used.

The steps from casting to drying may be performed in an air atmosphere or an inert gas atmosphere such as nitrogen gas. The take-up machine used for the production of the cellulose acylate film of the present invention may be a generally employed machine, and the film can be taken up by a take-up method such as constant tension method, constant torque method, taper tension method and programmed tension control method of keeping constant the inner stress.

### [Stretching Treatment]

For the Re reverse-dispersion film of the present invention, a cellulose acylate film subjected to a stretching treatment (stretched cellulose acylate film) is preferably used. By the stretching treatment, a desired retardation can be imparted to the cellulose acylate film. As for the stretching direction of the cellulose acylate film, either the width direction or the longitudinal direction is preferred.

The stretching method in the width direction is described, for example, in JP-A-62-115035, JP-A-4-152125, JP-A-4-284211, JP-A-4-298310 and JP-A-11-48271.

The stretching of the film is performed under heating condition. The film may be stretched by a treatment during drying, and this is effective particularly when the solvent remains. In the case of stretching in the longitudinal direction, for example, the film can be stretched by adjusting the speed of the film conveying roller to make the film take-up speed higher than the film separation speed. In the case of stretching in the width direction, the film can be stretched also by conveying the film while keeping the film width by a tenter and gradually increasing the width of the tenter. The film may also be stretched using a stretching machine (preferably uniaxial stretching using a long stretching machine) after drying.

The stretching of the resin film of the present invention is preferably performed at a temperature from (glass transition temperature of film −5° C.) to (glass transition temperature of film+40° C.). In the case of dry film, the stretching temperature is preferably from 130 to 200° C.

Also, in the case of performing the stretching in a state of the dope solvent remaining after casting, stretching at a temperature lower than that for the dry film can be performed and in this case, the stretching temperature is preferably from 100 to 170° C.

The stretch ratio (percentage elongation based on the film before stretching) of the Re reverse-dispersion film of the present invention is preferably from 1 to 200%, more preferably from 5 to 150%. Particularly, the film is preferably stretched in the width direction at a stretch ratio of 1 to 200%, more preferably from 5 to 150%. The stretching speed is preferably from 1 to 300%/min, more preferably from 10 to 300%/min, and most preferably from 30 to 300%/min.

The stretched cellulose acylate film of the present invention is preferably produced by, after stretching to a maximum stretch ratio, passing through a step of holding the film at a stretch ratio lower than the maximum stretch ratio for a fixed time (hereinafter, sometimes referred to as a “relaxing step”). The stretch ratio in the relaxing step is preferably from 50 to 99%, more preferably from 70 to 97%, and most preferably from 90 to 95%, based on the maximum stretch ratio. Also, the time of the relaxing step is preferably from 1 to 120 seconds, more preferably from 5 to 100 seconds.

Furthermore, the Re reverse-dispersion film of the present invention can be preferably produced by a method containing a shrinking step of shrinking the film in the width direction while gripping the film.

In the production method containing a stretching step of stretching the film in the width direction and a shrinking step of shrinking the film in the film conveying direction (longitudinal direction), the film is held in a pantograph-type or linear motor-type tenter, and the distance between clips is gradually decreased in the conveying direction while stretching the film in the width direction, whereby the film can be shrunk.

In the method described above, the stretching step and the shrinking step are at least partially performed at the same time.

As regards the specific stretching apparatus for performing the above-described stretching step of stretching the film either in the longitudinal direction or in the width direction and at the same time, shrinking the film in the other direction to simultaneously increase the thickness of the film, a FITZ machine manufactured by Ichikin Industry Co., Ltd. may be suitably used. This stretching machine is described in JP-A-2001-38802.

As for the stretch ratio in the stretching step and the percentage shrinking in the shrinking step, an appropriate value may be arbitrarily selected according to the objective values of in-plane retardation Re and retardation Rth in a thickness direction, but it is preferred that the stretch ratio in the stretching step is 10% or more and the percentage shrinking in the shrinking step is 5% or more.

In particular, the method preferably contains a stretching step of stretching the film by 10% or more in the width direction and a shrinking step of shrinking the film by 5% or more in the conveying direction while gripping the film in the film width direction.

Here, the term “percentage shrinkage” as used in the present invention means a ratio of the shrunk length of the film after shrinking to the length of the film before shrinkage in the shrinking direction.

The percentage shrinkage is preferably from 5 to 40%, more preferably from 10 to 30%.

The characteristic features of the resin film of the present invention are described in detail below.

### [Retardation of Film]

The resin film (sometimes referred to as a “reverse-dispersion film”) satisfies the relations of the following formulae (1) to (4).

20 nm<Re(548)<300 nm (1)

0.5<Re(446)/Re(548)<1.0 (2)

1.0<Re(629)/Re(548)<2.0 (3)

0.1%≦[{(Re(548) at 25° C.—10% RH−Re(548) at 25° C.—80% RH)×100}/Re(548) at 25° C.—60% RH]≦20% (4)

(wherein Re(λ) indicates the in-plane retardation at a wavelength of λ).

Furthermore, the resin film preferably satisfies the relation of the following formula (5):

0.0005<Re(548)/film thickness<0.00700 (5)

(provided that in formula (5), Re(548) and the film thickness both are indicated in nm).

In formula (1), Re(548) is preferably from 30 to 200 nm, more preferably from 50 to 150 nm.

In formula (2), Re(446)/Re(548) is preferably from 0.55 to 0.95, more preferably from 0.60 to 0.90.

In formula (3), Re(629)/Re(548) is preferably from 1.01 to 1.5, and most preferably from 1.03 to 1.2.

By controlling the retardation of the resin film to fall in the above-described ranges, a film reduced in the color tint change can be obtained.

In formula (4), [{(Re(548) at 25° C.—10% RH−Re(548) at 25° C.—80% RH)×100}/Re(548) at 25° C.—60% RH] is preferably from 0.1 to 10%.

In formula (5), Re(548)/film thickness is preferably from 0.00150 to 0.00650, and most preferably from 0.00170 to 0.00600.

By using a resin film where the Re humidity dependency is set to the above-described ranges, a liquid crystal display device hardly causing light leakage even when lighted for a long time in a high-humidity condition is obtained.

In the present invention, Re(λ) and Rth(λ) indicate the in-plane retardation and the retardation in a thickness direction, respectively, at a wavelength of λ. Re(λ) is measured by making light at a wavelength of λ nm to be incident in the film normal direction in KOBRA 21ADH or WR (manufactured by Oji Scientific Instruments).

In the case where the film measured is a film expressed by a uniaxial or biaxial refractive index ellipsoid, the Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the in-plane slow axis (judged by KOBRA 21ADH or WR) being used as the inclination axis (rotation axis) (when the slow axis is not present, an arbitrary direction in the film plane is used as the rotation axis) and based on the retardation values measured, the assumed value of average refractive index and the film thickness value input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, the assumed value of average refractive index and the film thickness value input, Rth can also be calculated according to the following formulae (21) and (22).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nx cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 21 )$$

### Note:

In formula (21), Re(θ) represents the retardation value in the direction inclined at an angle of θ from the normal direction, nx represents the refractive index in the in-plane slow axis direction, ny represents the refractive index in the direction crossing with nx at right angles in the plane, nz represents the refractive index in the direction crossing with nx and ny at right angles, and d represents the film thickness.

Rth=((nx+ny)/2−nz)×d Formula (22)

In the case where the film measured is a film incapable of being expressed by a uniaxial or biaxial refractive index ellipsoid or a film not having a so-called optic axis, Rth(λ) is calculated by the following method.

The Re(λ) is measured at 11 points by making light at a wavelength of λ nm to be incident from directions inclined with respect the film normal direction in 10° steps from −50° to +50° with the in-plane slow axis (judged by KOBRA 21ADH or WR) being used as the inclination axis (rotation axis) and based on the retardation values measured, the assumed value of average refractive index and the film thickness value input, Rth(λ) is calculated by KOBRA 21ADH or WR.

In the measurement above, as for the assumed value of average refractive index, those described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

The expression “reverse dispersion of Re is large” as used in the present invention indicates that the value of Re(446)/Re(548) is small and the value of Re(629)/Re(548) is large.

### [Photoelasticity of Resin Film]

The photoelastic coefficient of the resin film of the present invention is preferably from 0 to 30×10⁻⁸ cm²/N, more preferably from 0 to 20×10⁻⁸ cm²/N. When the photoelastic coefficient of the resin film is in the above-described range, this provides an effect of enabling reduction in the light leakage of a liquid crystal display device when lighted for a long time under high-humidity and high-temperature conditions.

The photoelastic coefficient can be determined by preparing a film cut out into a size of 3.5 cm×12 cm and a thickness of 30 to 150 μm and measuring Re at a wavelength of 630 nm without a load or under a load of 250 g, 500 g, 1,000 g or 1,500 g and calculated from the gradient of a straight line of the Re change with respect to the stress. As for the measuring device, an ellipso-meter (M150, manufactured by JASCO Corporation) is used.

If a structure having large polarizability anisotropy is introduced into the polymer so as to obtain high Re developability, the photoelastic coefficient of the resin film becomes large. However, in the case of an additive, even when a substituent having large polarizability anisotropy is introduced, this causes less change in the photoelastic coefficient of the resin film. By combining a polymer having a small photoelastic coefficient and an additive having large polarizability anisotropy, a resin film with large Re and small photoelastic coefficient can be obtained.

### [Thickness of Stretched Cellulose Acylate Film]

The thickness of the cellulose acylate film for use in the present invention is preferably from 30 to 100 μm, more preferably from 30 to 80 atm, and most preferably from 30 to 60 μm.

The resin film satisfying formulae (8) to (12) of the present invention (simply referred to as a “Rth forward-dispersion film”), which can be used in combination with the reverse-dispersion resin film of the present invention, is described below.

### [Rth Forward-Dispersion Film]

The polarizing plate protective film having the characteristic features of the following formulae (8) to (12) is described below. Such a protective film is preferably disposed on the side opposite the liquid crystal cell-side protective film comprising the Re reverse-dispersion film of the present invention, across the liquid crystal cell.

Formula (8) is more preferably 0 nm<Re(548)<15 nm and most preferably 0 nm<Re(548)<10 nm.

Formula (9) is more preferably 70 nm<Rth(548)<280 nm and most preferably 70 nm<Rth(548)<250 nm.

Formula (10) is more preferably 15<Rth(548)/Re(548) and most preferably 20<Rth(548)/Re(548).

Formula (11) is more preferably 1.01<Rth(446)/Rth(548)<1.8 and most preferably 1.01<Rth(446)/Rth(548)<1.5.

Formula (12) is more preferably 0.5<Rth(629)/Rth(548)<1.0 and most preferably 0.7<Rth(629)/Rth(548)<0.98.

By setting Re(λ) and Rth(λ) to fall in the above-described ranges, a polarizing plate protective film having a large effect of reducing the tint change depending on the viewing angle can be obtained.

As for the polarizing plate protective film having the characteristic features of formulae (8) to (12) (hereinafter referred to as an “Rth forward-dispersion film”), various polymer films can be used. The polymer film is preferably a polymer film such as polycarbonate, cycloolefin-based polymer and cellulose acylate. Among these, a cellulose acylate is preferred in view of suitability for processing into a polarizing plate. Incidentally, an Rth forward-dispersion film containing a cellulose acylate in an amount of 50 mass % or more is hereinafter sometimes referred to as an “Rth forward-dispersion cellulose acylate film”.

The retardation of the cellulose acylate film used for the Rth forward-dispersion film of the present invention can be adjusted by various methods. Among these methods, adjustment by an Rth developer described later, and adjustment by stretching of the film may be preferably used. The “Rth developer” as used herein is a compound having a property of developing birefringence in the thickness direction of the film.

The Rth developer for use in the present invention is preferably a compound having an absorption maximum in the wavelength range of 250 to 380 nm and having large polarizability anisotropy.

### (Cellulose Acylate)

The cellulose acylate for use in the Rth forward-dispersion cellulose acylate film is described below.

The cellulose acylate is preferably a cellulose acetate having an acetylation degree of 2.00 to 2.98. The acetylation degree is more preferably from 2.2 to 2.96.

The cellulose acetate for use in the Rth forward-dispersion cellulose acylate film of the present invention preferably has a mass average polymerization degree of 350 to 800, more preferably from 370 to 600. Also, the cellulose acylate for use in the present invention preferably has a number average molecular weight of 70,000 to 230,000, more preferably from 75,000 to 230,000, and most preferably from 78,000 to 120,000.

The cellulose acylate for use in the Rth forward-dispersion cellulose acylate film of the present invention can be produced using the same raw materials and synthesis methods as those of the cellulose acylate used for the Re reverse-dispersion film of the present invention.

Also, the steps of dope preparation, casting, drying and separation in the production of the Rth forward-dispersion cellulose acylate film of the present invention may be performed in the same manner as in the production of the Re reverse-dispersion cellulose acylate film of the present invention.

### (Stretching)

The Rth forward-dispersion cellulose acylate film for use in the present invention may be subjected to a stretching treatment. The stretching is preferably uniaxial stretching only in the width direction or biaxial stretching in the width and conveying directions.

As regards the method for stretching the film in the width direction, the method described above in [Stretching Treatment] of the reverse-dispersion film may be used.

The biaxial stretching includes a simultaneous biaxial stretching method and a sequential biaxial stretching method, but a sequential biaxial stretching is preferred in view of continuous production. After casting a dope and separating the film from the band or drum, the film is stretched in the width direction (or longitudinal direction) and then stretched in the longitudinal direction (or width direction).

The stretch ratio of the Rth forward-dispersion cellulose acylate film for use in the present invention is, in the case of uniaxial stretching only in the width direction, preferably from 1.0 to 1.1 times, more preferably from 1.02 to 1.07 times.

In the case of biaxial stretching, the stretch ratios in the conveying direction and the width direction preferably satisfy the relation of the following formula (D).

0.01<(stretch ratio in perpendicular direction)−(stretch ratio in parallel direction)<0.1 Formula (D)

Formula (D) is more preferably 0.02<(stretch ratio in perpendicular direction)−(stretch ratio in parallel direction)<0.08.

When the stretch ratio is adjusted to such a range, orientation of cellulose acylate molecular chains, which is generated during conveyance, is cancelled and not only Re of the film can be adjusted to the preferred range but also the surface state can be greatly improved.

### (Thickness of Rth Forward-Dispersion Cellulose Acylate Film)

The thickness of the Rth forward-dispersion cellulose acylate film for use in the present invention is preferably from 10 to 200 μm, more preferably from 20 to 150 μm, and most preferably from 30 to 100 μm.

The Re reverse-dispersion film and Rth forward-dispersion film of the present invention each may be imparted with adherence to a polarizer material such as polyvinyl alcohol by applying an alkali saponification treatment thereto and can be used as a polarizing plate protective film. The saponification method is described in and [0212] of JP-A-2007-86748, and the production method for the polarizer of the polarizing plate and optical characteristics and the like of the polarizing plate are described in [0213] to [0255] of the same patent publication. Based on these descriptions, a polarizing plate using the film of the present invention as a protective film can be produced.

The cellulose acylate film of the present invention is preferably laminated to a polarizer so that the transmission axis of the polarizer and the slow axis of the cellulose acylate film of the antireflection film can run substantially in parallel.

In the liquid crystal display device of the present invention, it is preferred that the transmission axis of a first polarizing plate and the slow axis of a first retardation film are substantially in parallel and the transmission axis of a second polarizing plate and the slow axis of a second retardation film are substantially in parallel. The term “substantially in parallel” as used herein indicates that the slippage between the main refractive index nx direction of the first retardation film or second retardation film for use in the present invention and the transmission axis direction of the polarizing plate is within 1°. The slippage is within 1°, more preferably within 0.50. If the slippage exceeds 1°, the performance in terms of the polarization degree of the polarizing plate in a cross-Nicol state decreases to cause light-through and this is not preferred.

The single plate transmittance TT, parallel transmittance PT and cross transmittance CT of the polarizing plate are measured using UV3100PC (manufactured by Shimadzu Corporation). The measurement is performed in the range of 380 to 780 nm, and an average of 10 measurements is used for all of single plate transmittance, parallel transmittance and cross transmittance. The endurance test of the polarizing plate is performed as follows in two modes, that is, (1) a polarizing plate alone and (2) a polarizing plate laminated to glass through a pressure-sensitive adhesive. In the measurement of a polarizing plate alone, polarizing plates are combined such that the optically compensatory film is sandwiched between two polarizers, and two samples having the same crossing are prepared and measured. For the glass lamination mode, the polarizing plate is laminated on glass such that the optically compensatory film comes to the glass side, and two samples (about 5 cm×5 cm) are prepared. The single plate transmittance is measured by arranging the film side of this sample to face the light source. Two samples are measured, and the average of the obtained values is defined as the single plate transmittance. As regards the polarization performance, the single plate transmittance TT, the parallel transmittance PT and the cross transmittance CT are, in this order, preferably 40.0≦TT≦45.0, 30.0≦PT≦40.0 and CT≦2.0, more preferably 41.0≦TT≦44.5, 34≦PT≦39.0 and CT≦1.3 (units all are %). In the endurance test of the polarizing plate, the variation is preferably smaller.

In the polarizing plate of the present invention, when the polarizing plate is left standing at 60° C. and 95% RH for 500 hours, the variation ΔCT (%) of the single plate cross transmittance and the variation ΔP of the polarization degree preferably satisfy at least one of the following formulae (j) and (k):

−6.0≦ΔCT≦6.0 (j)

−10.0≦ΔP≦0.0 (k)

Here, the variation indicates a value obtained by subtracting the measured value before the test from the measured value after the test.

By satisfying this requirement, the stability of the polarizing plate during use or storage is ensured.

### <Functionalization of Polarizing Plate>

The polarizing plate of the present invention may also be preferably used as a functionalized polarizing plate by combining it with an antireflection film or brightness enhancing film for enhancing the visibility of a display or with an optical film having a functional layer such as hardcoat layer, forward scattering layer and antiglare layer. The antireflection film, brightness enhancing film, other functional optical films, hardcoat layer, forward scattering layer and antiglare layer are described in [0257] to [0276] of JP-A-2007-86748, and a functionalized polarizing plate can be produced based on these descriptions.

### [Liquid Crystal Display Device]

The liquid crystal display device of the present invention is described below.

The liquid crystal display device of the present invention is a liquid crystal display device comprising a liquid crystal cell and two polarizing plates disposed on both sides of the liquid crystal cell, wherein at least one of the liquid crystal cell-side protective films of the polarizing plate is the resin film of the present invention.

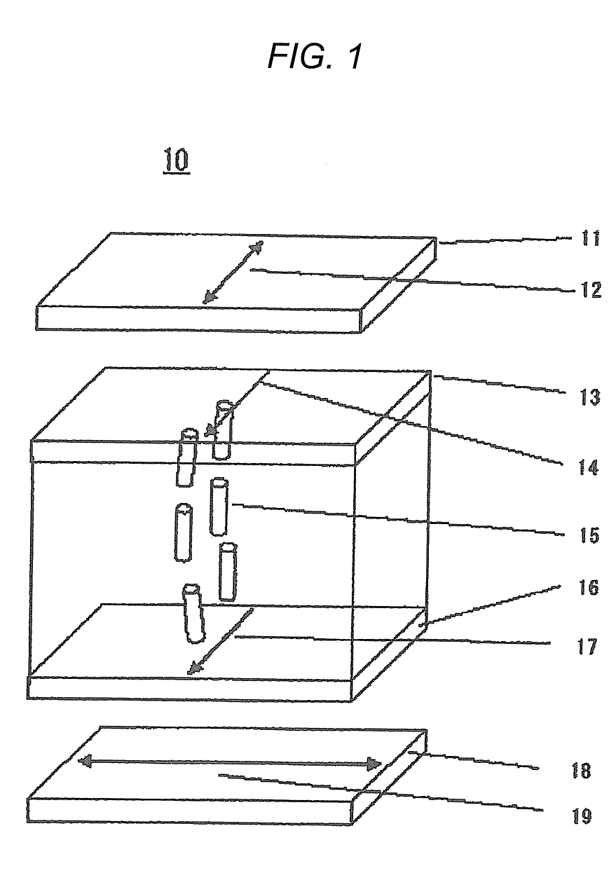

FIG. 1 is a schematic view showing an example of the liquid crystal display device of the present invention. In FIG. 1, the liquid crystal display device 10 comprises a liquid crystal cell having a liquid crystal layer 15 and having a liquid crystal cell upper electrode substrate 13 and a liquid crystal cell lower electrode substrate 16 disposed on the top and bottom of the liquid crystal layer, and further comprises an upper polarizing plate 11 and a lower polarizing plate 18 disposed on both sides of the liquid crystal cell. A color filter may be disposed between the liquid crystal cell and each polarizing plate. In the case of using the liquid crystal display 10 as a transmission type, a cold cathode or hot cathode fluorescent tube, or a backlight using, as a light source, a light-emitting diode, a field emission element or an electroluminescent element, is disposed in the back side.

The upper polarizing plate 11 and the lower polarizing plate 18 each has a stack construction of a polarizer being sandwiched by two protective films, and in the liquid crystal display device 10 of the present invention, it is preferred that the liquid crystal cell-side protective film of one polarizing plate has the characteristic features of formulae (1) to (4) and the liquid crystal cell-side protective film of another polarizing plate has the characteristic features of formulae (8) to (12). In the liquid crystal display device 10 of the present invention, a transparent protective film, a polarizer, and the cellulose acylate film of the present invention are preferably stacked in this order from the outer side (the side farther from the liquid crystal cell) of the device.

The liquid crystal display device 10 includes an image direct viewing type, an image projection type and an optical modulation type. The present invention is effective for an active matrix liquid crystal display device using a three-terminal or two-terminal semiconductor element such as TFT or MIM. Of course, the present invention is effective also for a passive matrix liquid crystal display device as represented by an STN mode called a time-division driving system.

### [VA Mode]

The liquid crystal cell of the liquid crystal display device of the present invention is preferably a VA-mode liquid crystal cell.

The VA-mode liquid crystal cell is produced by forming a layer from a liquid crystal having a negative dielectric anisotropy on the order of Δn=0.0813 and Δ∈=−4.6 between upper and lower substrates and performing rubbing orientation such that the director indicating the alignment direction of liquid crystal molecules, so-called a tilt angle, becomes about 89°. In FIG. 1, the thickness d of the liquid crystal layer 15 is set to 3.5 μm. Here, the brightness at the white display time varies depending on the size of the product Δnd of thickness d and refractive index anisotropy Δn. Therefore, the thickness of the liquid crystal layer is set to a range from 0.2 to 0.5 μm so as to obtain maximum brightness.

The polarizing plates are stacked such that the absorption axis 12 of the liquid crystal cell upper polarizing plate 11 and the absorption axis 19 of the lower polarizing plate 18 cross nearly at right angles. A transparent electrode (not shown) is formed on the inner side of each orientation film of the liquid crystal cell upper electrode substrate 13 and the liquid crystal cell lower electrode substrate 16. In the non-driven state of not applying a driving voltage to the electrodes, the liquid crystal molecules in the liquid crystal layer 15 are oriented in an alignment nearly vertical to the substrate surface, as a result, the polarizing state of light passing through the liquid crystal panel is scarcely changed. That is, the liquid crystal display device realizes an ideal black display in the non-driven state. On the other hand, in the driven state, the liquid crystal molecules are tilted to the direction parallel to the substrate surface, and the polarizing state of light passing through the liquid crystal panel is changed by these tilted liquid crystal molecules. In other words, the liquid crystal display device provides a white display in the driven state. Incidentally, in FIG. 1, numerals 14 and 17 indicate the alignment control direction.

Here, an electric field is applied between the upper and lower substrates and therefore, a liquid crystal material having negative dielectric anisotropy is used so that the liquid crystal molecule responds vertically with respect to the electric field direction. In the case where the electrodes are disposed on one substrate and the electric field is applied in the transverse direction parallel to the substrate surface, a liquid crystal material having positive dielectric anisotropy is used.

In the VA-mode liquid crystal display device, addition of a chiral material, which is generally performed in a TN-mode liquid crystal display device, causes deterioration in the dynamic response characteristics and therefore, a chiral compound is used less often but in some cases, may be added for reducing the alignment failure.

The characteristic features of the VA-mode are high-speed response and high contrast. However, this mode has a problem that the contrast which is high in the front deteriorates in the oblique direction. At the black display time, the liquid crystal molecules are oriented in an alignment vertical to the substrate surface. When viewed from the front, high contrast is obtained because the liquid crystal molecule has almost no birefringence and the transmittance is low. However, when viewed from an oblique direction, birefringence is produced in the liquid crystal molecule. Furthermore, the crossing angle between absorption axes of the upper and lower polarizing plates is a right angle of 90° when viewed from the front but exceeds 90° when viewed from the oblique direction. Because of these two factors, light leakage occurs in the oblique direction and the contrast decreases. In order to solve this problem, an optically compensatory sheet is disposed.

At the white display time, the liquid crystal molecules are tilted, but the size of birefringence of the liquid crystal molecule when viewed from the oblique direction greatly differs between the tilted direction and the opposite direction, and there arises a difference in the brightness or color tone. In order to solve this problem, a structure called multi-domain, where one pixel of the liquid crystal display is divided into a plurality of regions, is employed.

### [Multi-Domain]

For example, in the VA mode, when an electric field is applied, the liquid crystal molecules are tilted in a plurality of different regions within one pixel, whereby the viewing angle characteristics are averaged. For dividing the orientation within one pixel, a slit or protrusion is provided on the electrode to change the electric field direction or make uneven the electric-field density. In order to obtain a uniform viewing angle in all directions, this may be attained by increasing the number of divided regions. The viewing angle can be made nearly uniform by the division into 4 regions or 8 or more regions. In particular, when divided into 8 regions, the angle formed by absorption axes of the polarizing plates can be arbitrarily set and this is preferred.

The liquid crystal molecule can hardly respond on the border between regions created by the division of orientation. Therefore, black display is maintained at the normally black display, and this causes a problem that the brightness lowers. For solving this problem, the boundary region may be decreased by adding a chiral agent to the liquid crystal material.

### EXAMPLES

The present invention is described in greater detail below by referring to Examples, but the present invention is not limited to these Examples.

### Example 1

### Production of Re Reverse-Dispersion Film 101

### (Preparation of Cellulose Acylate Solution 11)

Cellulose Acylate Solution 11 was prepared by charging the following composition into a mixing tank and stirring it to dissolve respective components.

Composition of Cellulose Acylate Solution 11

| | |
|---|---|
| Cellulose acetate having an | 100.0 parts by mass |
| acetyl substitution degree of | |
| 2.94 and a polymerization | |
| degree of 380 | |
| Penta-O-acetyl-β-D- | 3.6 parts by mass |
| glucopyranose (produced by | |
| Tokyo Kasei Kogyo Co., Ltd., | |
| plasticizer) | |
| Methylene chloride (first | 402.0 parts by mass |
| solvent) | |
| Methanol (second solvent) | 60.0 parts by mass |

### (Preparation of Matting Agent Solution 12)

Matting Agent Solution 12 was prepared by charging the following composition into a disperser and stirring it to dissolve respective components.

Composition of Matting Agent Solution 12

| | |
|---|---|
| Silica particle having an | 2.0 parts by mass |
| average particle size of 20 nm | |
| (AEROSIL R972, produced by | |
| Nihon Aerosil Co., Ltd.) | |
| Methylene chloride (first | 75.0 parts by mass |
| solvent) | |
| Methanol (second solvent) | 12.7 parts by mass |
| Cellulose Acylate Solution 11 | 10.3 parts by mass |

### (Preparation of Retardation Developer Solution 13)

Retardation Developer Solution 13 was prepared by charging the following composition into a mixing tank and stirring it under heating to dissolve respective components.

Composition of Retardation Developer Solution 13

| | |
|---|---|
| Reverse-Dispersion Liquid | 11.0 parts by mass |
| Crystalline Compound (104) | |
| Rod-Like Liquid Crystalline | 9.0 parts by mass |
| Compound (8) | |
| Methylene chloride (first | 67.2 parts by mass |
| solvent) | |
| Methanol (second solvent) | 10.0 parts by mass |
| Cellulose Acylate Solution 11 | 12.8 parts by mass |

1.3 Parts by mass of Matting Agent Solution 12 and 8.7 parts by mass of Retardation Developer Solution 13 were mixed using an in-line mixer after filtering each solution, 90.0 parts by mass of Cellulose Acylate Solution 11 was further added and mixed using an in-line mixer, the mixture was then cast using a band casting machine, and the film was dried at 100° C. until reaching a residual solvent content of 40% and then stripped off. The film having a residual solvent content of 20% was transversely stretched at a stretch ratio of 32% by using a tenter at an ambient temperature of 150° C. and further kept at 130° C. for 3 minutes. After removing the clips, the film was dried at 130° C. for 30 minutes to produce Re Reverse-Dispersion Cellulose Acylate Film 101. The produced Re Reverse-Dispersion Cellulose Acylate Film 101 had a residual solvent amount of 0.1% and a thickness of 51 μm.

### Examples 2 to 5

### Production of Re Reverse-Dispersion Films 102 to 105

Re Reverse-Dispersion Films 102 to 105 were produced in the same manner except that in Example 1, the substitution degree of the cellulose acetate and the kind and amount of the additive were changed as shown in Table 1.

### Comparative Examples 1 to 5

### Production of Re Reverse-Dispersion Films 201 to 205

Re Reverse-Dispersion Films 201 to 205 were produced in the same manner except that in Example 1, the substitution degree of the cellulose acetate and the kind and amount of the additive were changed as shown in Table 1.

TABLE 1

| No. of Reverse- | Acetyl Substitution | Plasticizer | | | | | |
|---|---|---|---|---|---|---|---|
| Dispersion Cellulose | Degree of Cellulose | | Molecular | logP | | Amount | |
| Acylate Film | Acetate | Kind | Weight | Value | εₘₐₓ* | Added** | Remarks |
| 101 | 2.94 | PAG | 390 | −0.2 | 200 | 7.20 | Invention |
| 102 | 2.87 | COA | 679 | 1.0 | 200 | 3.60 | Invention |
| 103 | 2.95 | SOA | 606 | 1.0 | 200 | 7.20 | Invention |
| 104 | 2.95 | trimethyl | 252 | 1.5 | 1800 | 7.20 | Invention |
| | | trimellitate | | | | | |
| 105 | 2.86 | triethyl 1,3,5- | 294 | 3.6 | 2600 | 7.20 | Invention |
| | | benzenecarboxylate | | | | | |
| 201 | 2.94 | PAG | 390 | −0.2 | 200 | 7.20 | Comparative |
| | | | | | | | Example |
| 202 | 2.94 | none | — | — | — | 0.00 | Comparative |
| | | | | | | | Example |
| 203 | 2.94 | tri-n-butyl citrate | 361 | 4.4 | 200 | 7.20 | Comparative |
| | | | | | | | Example |
| 204 | 2.94 | TPP | 326 | 4.6 | 1300 | 7.20 | Comparative |
| | | | | | | | Example |
| 205 | 2.94 | Compound 20 described | 1485 | 2.9 | 200 | 7.20 | Comparative |
| | | in WO2007/125764 Al | | | | | Example |

| | Reverse-Dispersion | | | Rod-Like Liquid | | | Retardation | | | |
|---|---|---|---|---|---|---|---|---|---|---|
| No. of Reverse- | Liquid Crystal Compound | | | Crystal Compound | | | Developer | | Film | |
| Dispersion Cellulose | | logP | Amount | | logP | Amount | | Amount | Thickness | |
| Acylate Film | Kind | Value | Added** | Kind | Value | Added** | Kind | Added** | (μm) | Remarks |
| 101 | I-(104) | 13.6 | 6.0 | (8) | 5.8 | 5.0 | — | 0.0 | 50 | Invention |
| 102 | I-(20) | 13.2 | 4.8 | (33) | 6.8 | 5.0 | A | 0.8 | 60 | Invention |
| 103 | I-(92) | 14.1 | 5.0 | (34) | 7.9 | 5.5 | A | 0.5 | 71 | Invention |
| 104 | I-(104) | 13.6 | 6.0 | (8) | 5.8 | 5.0 | — | 0.0 | 50 | Invention |
| 105 | I-(104) | 13.6 | 6.0 | (8) | 5.8 | 5.0 | — | 0.0 | 50 | Invention |
| 201 | none | — | — | none | — | — | — | 0.0 | 50 | Comparative |
| | | | | | | | | | | Example |
| 202 | I-(104) | 13.6 | 6.0 | (8) | 5.8 | 5.0 | — | 0.0 | 50 | Comparative |
| | | | | | | | | | | Example |
| 203 | I-(104) | 13.6 | 6.0 | (8) | 5.8 | 5.0 | — | 0.0 | 50 | Comparative |
| | | | | | | | | | | Example |
| 204 | I-(104) | 13.6 | 6.0 | (8) | 5.8 | 5.0 | — | 0.0 | 50 | Comparative |
| | | | | | | | | | | Example |
| 205 | I-(104) | 13.6 | 6.0 | (8) | 5.8 | 5.0 | — | 0.0 | 50 | Comparative |
| | | | | | | | | | | Example |

*εₘₐₓ: Maximum value of molar extinction coefficient at a wavelength of 200 to 700 nm.
**Mass % based on cellulose acylate
PAG: Penta-O-acetyl-β-D-glucopyranose (produced by Tokyo Kasei Kogyo Co., Ltd.)
COA: Cellobiose octaacetate (produced by Tokyo Kasei Kogyo Co., Ltd.)
SOA: Saccharose octaacetate (produced by Tokyo Kasei Kogyo Co., Ltd.)
LogP Value: Measured by Crippen's fragmentation method.

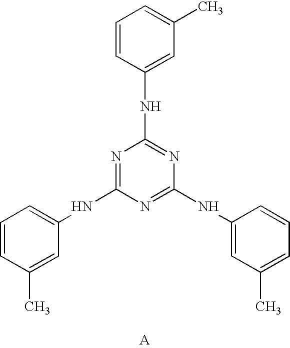

The thus-produced Re Reverse-Dispersion Films 101 to 105 and 201 to 205 were evaluated with an eye for the generation of bleed-out.

Re and Rth at wavelengths of 446 nm, 548 nm and 628 nm were measured by an automatic birefringence meter (KOBRA-WR, manufactured by Oji Test Instruments) at 25° C. and a relative humidity of 10%, 60% and 80%.

Furthermore, the film was cut into a size of 3.5 cm×12 cm, and Re of the film was measured without a load or under a load of 250 g, 500 g, 1,000 g or 1,500 g by an ellipsometer (M-150, JASCO Corp.). Then, the photoelastic coefficient was determined by calculation from the gradient of a straight line of the Re change for the stress.

The results are shown in Table 2 below.

TABLE 2

| | | | | | | | | | | | Humidity | Photoelastic | |
|---|---|---|---|---|---|---|---|---|---|---|---|---|---|
| | | Re | Re | Re (446)/ | Re (629)/ | Rth | Rth | Rth | Rth (446)/ | Rth (629)/ | Dependency^{a)} | Coefficient | |
| | Re (446) | (548) | (629) | Re (548) | Re (548) | (446) | (548) | (629) | Rth (548) | Rth (548) | of Re | (×10⁻⁸ cm²/N) | Remarks |
| 101 | 78 | 95 | 100 | 0.82 | 1.05 | 96 | 117 | 128 | 0.82 | 1.09 | 2% | 14 | Invention |
| 102 | 108 | 124 | 127 | 0.87 | 1.03 | 134 | 154 | 162 | 0.88 | 1.05 | 2% | 12 | Invention |
| 103 | 104 | 119 | 122 | 0.87 | 1.02 | 130 | 146 | 153 | 0.89 | 1.05 | 2% | 13 | Invention |
| 104 | 97 | 104 | 107 | 0.93 | 1.03 | 125 | 135 | 140 | 0.93 | 1.04 | 2% | 14 | Invention |
| 105 | 90 | 98 | 103 | 0.92 | 1.05 | 115 | 122 | 126 | 0.94 | 1.03 | 2% | 15 | Invention |
| 201 | −15 | −11 | −10 | 1.36 | 0.86 | −11 | 1 | 2 | −10.9 | 2.00 | 50% | 10 | Comparative |
| | | | | | | | | | | | | | Example |
| 202 | 70 | 85 | 90 | 0.82 | 1.06 | 100 | 125 | 136 | 0.80 | 1.09 | 4% | 14 | Comparative |
| | | | | | | | | | | | | | Example |
| 203 | 65 | 78 | 82 | 0.83 | 1.05 | 93 | 108 | 116 | 0.86 | 1.07 | 4% | 12 | Comparative |
| | | | | | | | | | | | | | Example |
| 204 | 75 | 83 | 86 | 0.90 | 1.04 | 96 | 105 | 109 | 0.91 | 1.04 | 4% | 13 | Comparative |
| | | | | | | | | | | | | | Example |
| 205 | 74 | 87 | 91 | 0.85 | 1.05 | 92 | 111 | 120 | 0.83 | 1.08 | 4% | 12 | Comparative |
| | | | | | | | | | | | | | Example |

* Humidity dependency of Re = [(Re (548) at 25° C.-10% RH − Re (548) at 25° C.-80% RH]/Re (548) at 25° C.-60% RH

As seen Table 2, in Re Reverse-Dispersion Films 101, 104 and 105 of the present invention using a plasticizer and a liquid crystalline compound, preferred results are obtained, that is, Re and Rth are large and the Re change depending on the ambient temperature is small as compared with Comparative Examples 201 to 205, despite the same amount of the liquid crystalline compound added and the same film thickness. Above all, Re Reverse-Dispersion Film 101 of the present invention is particularly preferred because, despite the same amount of the liquid crystalline compound added, the value of Re(446)/Re(548) is smaller and the reverse dispersibility is higher than Re Reverse-Dispersion Films 104 and 105.

### Example 7

### Saponification of Re Reverse-Dispersion Film 101

Re Reverse-Dispersion Film 101 produced was dipped in an aqueous 2.3 mol/L sodium hydroxide solution at 55° C. for 3 minutes, and the film is then washed in a water-washing bath at room temperature, further neutralized using 0.05 mol/L sulfuric acid at 30° C., again washed in a water-washing bath at room temperature and dried with hot air at 100° C. In this way, the surface of Re Reverse-Dispersion Film 101 was saponified.

### Example 8

### Production of Polarizing Plate 101

A polarizer was produced by adsorbing iodine to a stretched polyvinyl alcohol film.

Re Reverse-Dispersion Film 101 saponified in Example 7 was laminated to one side of the polarizer by using a polyvinyl alcohol-based adhesive. Furthermore, a commercially available cellulose triacetate film (FUJI-TAC TD80UF, produced by Fujifilm Corp.) was saponified in the same manner and laminated to the side opposite the Re Reverse-Dispersion Film 101 by using a polyvinyl alcohol-based adhesive.

The transmission axis of the polarizer and the slow axis of Re Reverse-Dispersion Film 101 were arranged to run in parallel. Also, the transmission axis of the polarizer and the slow axis of the commercially available cellulose triacetate film were arranged to cross at right angles.

In this way, Polarizing Plate 101 was produced.

### Reference Example 1

### Production of Rth Forward-Dispersion Cellulose Acylate Film 301

### (Preparation of Cellulose Acylate Solution 31)

Cellulose Acylate Solution 31 was prepared by charging the following composition into a mixing tank and stirring it to dissolve respective components.

Composition of Cellulose Acylate Solution 31

| | |
|---|---|
| Cellulose acetate having an | 100.0 parts by mass |
| acetyl substitution degree of | |
| 2.87 and an average | |
| polymerization degree of 360 | |
| Triphenyl phosphate | 7.0 parts by mass |
| Biphenyl phosphate | 4.0 parts by mass |
| Methylene chloride (first | 402.0 parts by mass |
| solvent) | |
| Methanol (second solvent) | 60.0 parts by mass |

### (Preparation of Matting Agent Solution 32)

Matting Agent Solution 32 was prepared by charging the following composition into a disperser and stirring it to dissolve respective components.

Composition of Matting Agent Solution 32

| | |
|---|---|
| Silica particle having an | 2.0 parts by mass |
| average particle size of | |
| 20 nm (AEROSIL R972, produced | |
| by Nihon Aerosil Co., Ltd.) | |
| Methylene chloride (first | 75.0 parts by mass |
| solvent) | |
| Methanol (second solvent) | 12.7 parts by mass |
| Cellulose Acylate Solution 31 | 10.3 parts by mass |

### (Preparation of Retardation Developer Solution)

A wavelength-dispersion controlling agent solution was prepared by charging the following composition into a mixing tank and stirring it under heating to dissolve respective components.

Composition of Retardation Developer Solution 33

| | |
|---|---|
| Retardation Developer A used | 20.0 parts by mass |
| in Example 2 | |
| Methylene chloride (first | 58.4 parts by mass |
| solvent) | |
| Methanol (second solvent) | 8.7 parts by mass |
| Cellulose Acylate Solution 31 | 12.8 parts by mass |

92.9 Parts by mass of Cellulose Acylate Solution 31, 1.3 parts by mass of Matting Agent Solution 32 and 5.8 parts by mass of Wavelength-Dispersion Controlling Agent Solution 33 were mixed after filtering each solution, the mixture was then cast in a width of 1,600 mm by using a band casting machine, and the film in a state of having a residual solvent content of 50 mass % was stripped off from the band, transversely stretched at a stretch ratio of 2% while holding the film by tenter clips under the conditions of 100° C. and dried until the residual solvent content became 5 mass % (Drying 1). The film was held at 100° C. for 30 seconds by keeping the width after stretching and then liberated from the tenter clips. After slitting respective portions of 5% from both ends in the width direction, the film was passed through a drying zone at 135° C. over 20 minutes in a state of the width direction being in a free state (not held) (Drying 2) and then taken up into a roll. The cellulose acylate film obtained had a residual solvent amount of 0.1 mass % and a thickness of 52 μm. Also, Rth(446) was 113 nm, Rth(548) was 107 nm and Rth(629) was 105 nm.

### Reference Example 3

### Saponification Treatment of Rth Forward-Dispersion Cellulose Acylate Film 301

Rth Forward-Dispersion Cellulose Acylate Film 301 produced was dipped in an aqueous 2.3 mol/L sodium hydroxide solution at 55° C. for 3 minutes, then washed in a water-washing bath at room temperature, further neutralized using 0.05 mol/L sulfuric acid at 30° C., again washed in a water-washing bath at room temperature and dried with hot air at 100° C. In this way, the surface of Rth Forward-Dispersion Film 301 was saponified.

### [Production of Polarizing Plate 301]

### (Saponification of Polarizing Plate Protective Film)

A commercially available cellulose acetate film (FUJI-TAC TD80, produced by Fuji Photo Film Co., Ltd.) was dipped in an aqueous 1.5 mol/L sodium hydroxide solution at 55° C. for 1 minute, then washed in a water-washing bath at room temperature, further neutralized using 0.05 mol/L sulfuric acid at 30° C., again washed in a water-washing bath at room temperature and dried with hot air at 100° C.

### (Production of Polarizer)

A polarizer was produced by adsorbing iodine to a stretched polyvinyl alcohol film, and Rth Forward-Dispersion Cellulose Acylate Film 301 saponified above was laminated to one side of the polarizer by using a polyvinyl alcohol-based adhesive. The absorption axis of the polarizer and the slow axis of the cellulose acylate film were arranged to run in parallel.

Furthermore, the commercially available cellulose triacetate film saponified above was laminated to the opposite side by using a polyvinyl alcohol-based adhesive. In this way, Polarizing Plate 301 was produced.

### Example 12

### Production of Liquid Crystal Display Device

After stripping off two polarizing plates of a commercially available liquid crystal television set (BRAVIA J5000, manufactured by SONY Corp.), one sheet of Polarizing Plate 301 of the present invention and one sheet of Polarizing Plate 101 of the present invention were laminated to the viewer side and the backlight side, respectively, through a pressure-sensitive adhesive agent such that Re Reverse-Dispersion Film 101 and Rth Forward-Dispersion Cellulose Acylate Film 301 each came to the liquid crystal cell side. These polarizing plates were disposed in a cross-Nicol arrangement where the transmission axis of the polarizing plate on the viewer side ran in the up/down direction and the transmission axis of the polarizing plate on the backlight side ran in the right/left direction. When the thus-produced liquid crystal display device of the present invention was observed from the oblique direction, high contrast and small color tint change were advantageously obtained as compared with the commercially available liquid crystal television set.

What is claimed is:

1. A resin film comprising at least one liquid crystalline compound and a plasticizer having an octanol/water partition coefficient of from −2 to 4 and a molecular weight of from 200 to 1,400.

2. The resin film as claimed in claim 1, wherein the plasticizer has a molar extinction coefficient of 500 or less at all wavelengths of from 200 to 700 nm.

3. The resin film as claimed in claim 1, wherein the plasticizer is a carbohydrate derivative.

4. The resin film as claimed in claim 1, wherein a compound represented by the following formula (I) is contained as the liquid crystalline compound in an amount of from 0.1 to 30 mass % of the resin film: 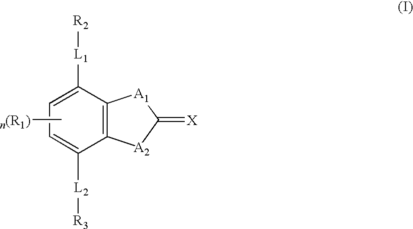
wherein L₁ and L₂ each independently represents a single bond or a divalent linking group; A₁ and A₂ each independently represents a group selected from the group consisting of —O—, —NR— in which R represents a hydrogen atom or a substituent, —S— and —CO—; R₁, R₂ and R₃ each independently represents a substituent; X represents an atom of Group 6, 5 or 4 of a periodic table; and n represents an integer of from 0 to 2.

5. The resin film as claimed in claim 1, wherein a compound represented by the following formula (1) is contained as the liquid crystalline compound in an amount of from 0.1 to 30 mass % of the resin film:
Ar¹-L²-X-L³-Ar² (1)
wherein Ar¹ and Ar² each independently represents an aromatic group; L² and L³ each independently represents a divalent linking group selected from a —O—CO— group and a —CO—O— group; and X represents a 1,4-cyclohexylene group, a vinylene group or an ethynylene group.

6. The resin film as claimed in claim 1, wherein relations of the following formulae (1) to (4) are satisfied and a photoelastic coefficient is from 0 to 30×10⁻⁸ cm²/N:
20 nm<Re(548)<300 nm (1)
0.5<Re(446)/Re(548)<1.0 (2)
1.0<Re(629)/Re(548)<2.0 (3)
0.1%≦[{(Re(548) at 25° C.—10% RH−Re(548) at 25° C.—80% RH)×100}/Re(548) at 25° C.—60% RH]≦20% (4)
wherein Re(λ) indicates in-plane retardation at a wavelength of λ.

7. The resin film as claimed in claim 1, wherein a relation of the following formula (5) is satisfied:
0.0005<Re(548)/film thickness<0.00700 (5)
wherein Re(548) indicates in-plane retardation at a wavelength of 548 nm, provided that Re(548) and the film thickness both are indicated in nm.

8. The resin film as claimed in claim 1, further comprising a cellulose acylate in an amount of 50 mass % or more of the resin film.

9. A polarizing plate comprising two protective films and a polarizer provided between the two protective films, wherein at least one of the two protective films is the resin film claimed in claim 1.

10. A liquid crystal display device comprising two polarizing plates and a liquid crystal cell provided between the two polarizing plates, the two polarizing plates each comprising two protective films and a polarizer provided between the two protective films, wherein at least one of the liquid crystal cell-side protective films of the polarizing plates is the resin film claimed in claim 1.

11. The liquid crystal display device as claimed in claim 10, wherein a liquid crystal cell-side protective film on an opposite side across the liquid crystal cell with respect to the liquid crystal cell-side protective film comprising the resin film claimed in claim 1 satisfies relations of the following formulae (8) to (12):
0 nm<Re(548)<20 nm (8)
100 nm<Rth(548)<300 nm (9)
10<Rth(548)/Re(548) (10)
1.0<Rth(446)/Rth(548)<2.0 (11)
0.5<Rth(629)/Rth(548)<1.0 (12)
wherein Re(λ) and Rth(λ) indicate an in-plane retardation and a retardation in thickness direction, respectively, at a wavelength of λ.

12. The liquid crystal display device as claimed in claim 10, wherein the liquid crystal call is a VA-mode liquid crystal cell.
